(19) United States
(12) Patent Application Publication
(10) Pub. No.: US 2013/0144754 A1
(43) Pub. Date: Jun. 6, 2013

(54) E-COMMERCE METHOD AND SYSTEM

(71) Applicant: George Moser, Redwood City, CA (US)

(72) Inventor: George Moser, Redwood City, CA (US)

(21) Appl. No.: 13/424,309

(22) Filed: Mar. 19, 2012

Related U.S. Application Data
(63) Continuation-in-part of application No. 13/310,794, filed on Dec. 4, 2011.

(51) Int. Cl. G06Q 30/06

(52) U.S. Cl. 705/26.35; 705/26.61; 705/26.41; 705/26.62

(57) ABSTRACT

A social e-commerce system is provided. To the extent buyers seek products not already available, the system matches buyers with related sellers and solicits listing on the sought-after items. The system includes third party certification options. Enhanced communication facilities between buyers and sellers enable reduced opportunity for dispute. Intra-party communications during the transaction can be utilized by third party neutrals for dispute resolution. Parties can select trust agents for escrow and/or dispute resolution.

### RELATED APPLICATION DATA

This application is a continuation-in-part of Ser. No. 13/310,794 filed Dec. 4, 2011, and priority is claimed for this earlier filing under 35 U.S.C. Sec. 120.

### TECHNICAL FIELD

The invention is in the field of computer-based electronic commerce methods and systems, particularly those relying on the Internet.

### BACKGROUND

E-commerce has achieved a substantial level of success, with billions of dollars being traded on-line through the Internet every year. J.P. Morgan has been reported as forecasting that by 2015 e-commerce will reach approximately $1 trillion in worldwide sales revenue. However, a large part of the market remains untapped. E-commerce sales revenue is believed to be only about 8% of the total retail sales revenue in the U.S., and an even smaller fraction abroad. This may be largely due to the methodology used by typical e-commerce companies. This methodology is based on having the buyer pay the seller upfront, before receiving the merchandise being purchased. After receiving full payment, the seller ships the merchandise to the buyer. If the merchandise fits the description and condition of the items offered, that concludes the transaction. However, if the buyer is dissatisfied with the items, a resolution process starts that can take weeks or months and which is made especially difficult because the buyer has little leverage, since the merchandise is already paid in full.

The lengthy and difficult resolution process leads to many buyers giving up on their complaint and just accepting the loss, therefore getting stuck with an item they don't like. These buyers may become reluctant to buy online again.

Many potential buyers are reluctant to buy online in the first place, due to perceptions that current systems disproportionately favor the seller over the buyer, because upfront full payment before shipment gives the seller too much leverage. By contrast, items purchased in-person can be inspected by the buyer before payment. Reputable sellers don't take advantage of this bias in the system, but the Internet includes millions of potential sellers, some reputable and many who are not. The buyer in many cases doesn't know what type of company or individual he/she is buying from, and he/she may perceive the transaction as too risky—and not order online.

There have been some attempts to design an ecommerce system that would address the issue of current bias in favor of the seller. U.S. Pat. No. 7,734,520 proposes an escrow system based on an inspection system where the buyer is required to go inspect the items upon delivery to a local warehouse or facility before payment is released to the seller. Some users may consider such a system to be impractical, too expensive and not acceptable because of the hassle of having to travel to inspect items.

U.S. Pat. No. 8,051,150 tries to address the reluctance of many potential online buyers to order online by having a website acting as an intermediary in the transaction and hiding the identity of the parties to the transaction from each other to avoid disclosure of sensitive financial information, such as credit card number or bank account numbers. However such a system does not address the bias in favor of the seller created by the approach of having the buyer pay full price upfront before shipping.

Another unintended consequence of many current systems is some buyers tend not to use e-commerce for large purchases, because of the risk involved. Some buyers may perceive that risk as acceptable for a small ticket item such as a $5 book. But for a $50,000 item it may seem too risky to some potential buyers, since the resolution of a possible dispute is potentially very difficult because of the “full pay upfront” approach.

The current pay upfront approach also takes the incentive away from sellers to ship the merchandise as quickly as possible and to package it correctly. The transaction is already done and the seller is already paid.

Another issue for many potential buyers is that e-commerce sites such as eBay typically use the auction approach, which means that even if the desired item is found, it may not be available for several days. That is OK for some items, but many buyers would prefer to find what they want and order it without having to wait for the end of an auction. A so-call “buy it now” option is available for some items, but the majority of items are subject to the auction waiting period. Many people don't have the time or inclination to engage in an auction and wait a relatively long time for an item they want right away.

Another issue with many current systems is that the site facilities provided to show the items for sale rely primarily on photographs and text descriptions of the item posted on the site. But photographs may show the item only from the most favorable side/angle, where another view may reveal that the item is dented, cracked, scratched or otherwise damaged. A photograph also does not show or prove that the items is functional, which in many cases is a basic criterion for a purchase (for instance, a buyer of some electronic equipment ideally would like to know if the equipment actually works properly before buying it). Meanwhile, the buyer is expected to pay full-price upfront and take the risk.

A further aspect of current e-commerce systems is that they often don't support terms of credit, such as net 30, net 60 or other terms that are customary in commercial transactions, but rather support only cash or credit card purchases (or variations thereof such as paypal). However, parties to commercial transactions often desire or require other credit terms.

Another characteristic of many current e-commerce systems is that they discourage international transactions. The “pay upfront in full and then hope for the best” approach works in many cases for small ticket items within the national borders, but for transactions involving a seller abroad the risk is generally perceived as too high. That can eliminate from consideration international suppliers that otherwise could be highly competitive or even superior options, thereby disadvantaging both sellers and buyers. The excessive bias of the current system in favor of the seller ends up hurting sellers trying to sell their items into other countries, by sometimes eliminating them from consideration. That includes not only Asian sellers trying to sell in the U.S. and Europe, but also American sellers trying to sell globally. The current system bias in e-commerce may generally act to everybody's disadvantage.

### SUMMARY

In accordance with one embodiment disclosed herein, a computer-based system for conducting electronic commercial transactions amongst a plurality of buyers and sellers via the Internet is provided. An electronic warehouse database contains information describing one or more items available for sale. One or more databases also contain transaction data, buyer information and seller information. A computer application acts to manage the databases. A computer application further operates to communicate with buyer and sellers via a web server in order to conduct a sales transaction using the Internet. The system further provides an electronic disclosure facility. The electronic disclosure facility implements data storage and communications mechanisms through which information describing the items for sale is stored, such as text descriptions, statistics and characteristics; standardized item specifications and standardized digital photographs of an item. Furthermore, an electronic showroom facility provide audio-video storage and playback modules which allows buyers and sellers to communicate with one another, such as via videoconferencing. An electronic cubicle facility can be provided, through which a buyer and seller can negotiate terms of a transaction prior to completing the transaction, such as via messaging, text chat conferencing, text and video conferencing, and videoconferencing. Through such enhanced communication, buyers and sellers can better clarify expectations and exchange important information prior to completing a transaction.

A dispute resolution module may be provided for facilitating resolution of disputes concerning transactions implemented via the system. The dispute resolution module may evaluate information contained within the electronic disclosure facility, the electronic showroom facility and/or the electronic cubicle facility. This information can also be made accessible via an arbitrator portal within the web site.

A computer-implemented method for resolving a dispute between parties to a transaction conducted via an electronic commerce system is also disclosed. The method involves providing a website-based complaint user interface through which one party and submit information describing the dispute. A website-based neutral user interface is provided through which a neutral party can access the submitted complaint, as well as information relating to the transaction stored within the electronic commerce system. An initial determination of the dispute by the neutral is communicated to the parties electronically. The initial determination can be accepted or rejected. If rejected, an online hearing facility is provided through which the parties can communicate with a neutral via the Internet. The parties are ultimately notified of the neutral's final determination, which is subsequently implemented. The losing party may be assessed a financial charge.

In accordance with yet another aspect of the embodiments, a computer-based system for conducting electronic commercial transactions is provided, in which parties to a transaction can select one from amongst a plurality of trust entities to be utilized in connection with the transaction. The trust entities may include one or more independent financial institutions. A data communications interface between the web site and the trust entities may be provided, and communications requesting the release of funds can be conducted electronically.

In connection with a further aspect of the embodiments, a computer-implemented method for conducting an electronic commercial transaction via the Internet includes receiving a search request for a desired item from a buyer, and identifying one or more relevant sellers who have items listed as available for sale that are similar to the desired item sought by the buyer. The relevant sellers can be notified that the desired item was sought by the buyer. Requests for desired items not otherwise available on the web site can be maintained in a database, and optionally made available to sellers.

Yet another aspect of the embodiments provides a computer-implemented method for conducting an electronic commercial transaction via the Internet, in which one or more merchandise certification authorities are associated with the sales web site. The web site can receive via electronic communication a certification of an item listed for sale by one of the sellers. Information from the certification can then be published within the sales listing on the web site. Sellers can be presented with a list of certification authorities having expertise associated with the item being made available for sale by the seller. A web-based communications portal can be made accessible to the certification authorities, and certification authorities can upload certification information to the web site via the portal. Certification information can be stored within a database.

These and other aspects of the embodiments are described further herein below.

### BRIEF DESCRIPTION OF THE DRAWINGS

FIGS. 1-3 are flowcharts of a prior art process for conducting an ecommerce transaction.

FIGS. 4-6 are flowcharts of a process for conducting an ecommerce transaction in accordance with an embodiment of the invention.

FIGS. 7-10 are flowcharts of a process for conducting a commercial ecommerce transaction with a request-for-quote process and optionally credit terms, in accordance with another embodiment of the invention.

FIGS. 11-21A are user interface illustrations for embodiments of the processes of FIGS. 4-10.

FIG. 21B is a flow chart of a process for dispute resolution in accordance with another electronic commerce system embodiment.

FIGS. 22-33 are further user interface illustrations for embodiments of the processes of FIGS. 4-10 and 21B.

FIG. 34 is a schematic block diagram of an ecommerce system.

FIG. 35 is a schematic process flowchart for matching buyer requests to potential sellers.

FIG. 36 is a schematic process flowchart for merchandise certification.

FIG. 37 is a process flowchart for use of a trust entity in an e-commerce transaction.

### DETAILED DESCRIPTION OF THE DRAWINGS

While this invention is susceptible to embodiment in many different forms, there are described in detail herein several specific embodiments, with the understanding that the present disclosure is to be considered as an exemplification of the principles of the invention and is not intended to limit the invention to the embodiments illustrated.

The embodiments illustrated herein describe a new system and method to conduct e-commerce that mitigates biases in many current systems and helps provide more similar or equal protection to both buyer and seller, which may be in the interest of both buyers and sellers to the extent it serves to expand the use of e-commerce. A less biased system that equally protects buyers and sellers could open up new markets for e-commerce, both nationally (more buyers because of more trust in the system, and also addition of bigger ticket items) and internationally (complete new continents with billions of buyers and sellers would be added to e-commerce). Some embodiments may also enable credit term based transactions (further expanding the e-commerce market size) to further enable and popularize commercial e-commerce.

It is believed that embodiments illustrated herein could facilitate opportunities for large-scale international e-commerce. Those embodiments may also have deep social and economic implications by providing social interaction tools that enable a buyer and seller anywhere in the world to conduct business, without the customary intermediaries that often make those transactions onerous and complex.

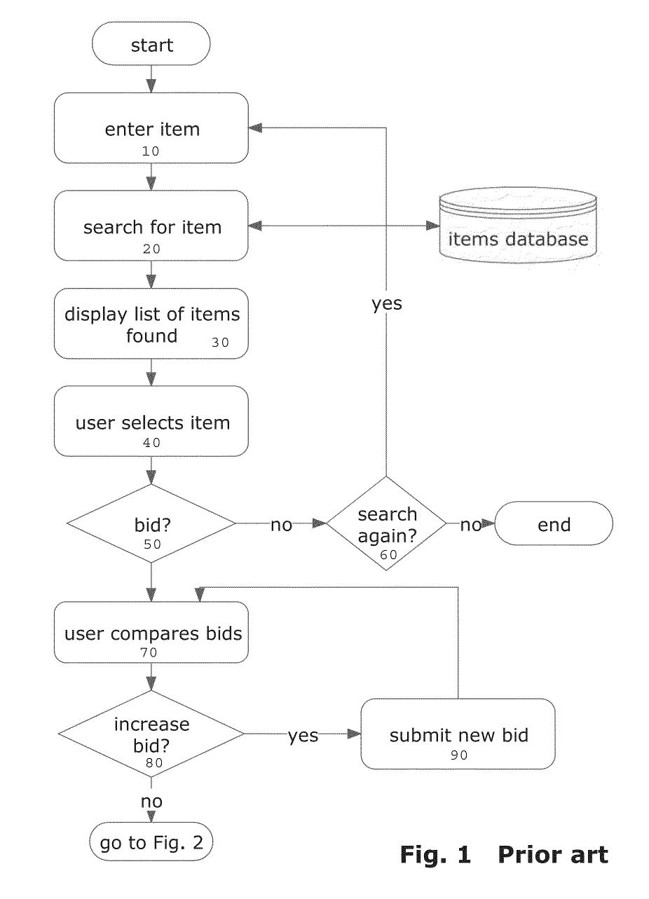

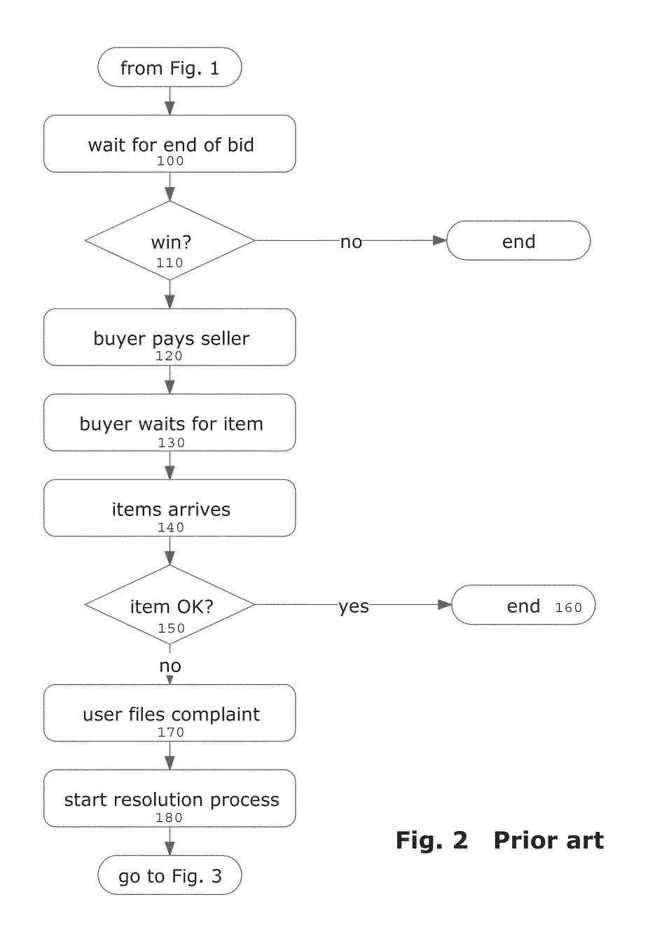

FIGS. 1 and 2 show a conventional prior art e-commerce system. The flow of the transaction is as follows:
The buyer enters the name of the item (or the category of items) (step 10);
the system conducts a search for the item in the system database, which contains the items that are offered for sale by registered sellers (step 20)
the system displays the matching items found in the system database (step 30)
the buyer selects the items that look interesting, reads the descriptions, views the photos displayed and then selects the most likely item (step 40);
The buyer decides whether or not to bid for the item selected (step 50);
If the decision is not to bid, the buyer can decide whether to start a new search for the same or another item (step 60);
If the user decides to bid, the system enters the bid and allows the user to compare his bid to other bids (step 70);
based on the previous comparison, the user may decide (step 80) to either a) submit a new bid for a higher amount (step 90), or b) await the end of the bid (and potentially submit a new bid near the end of the auction) (step 100, FIG. 2).
when the auction ends at a pre-defined time, the site notifies the winner of the auction and the seller (step 110);
the buyer now has to pay the full price of the item plus shipping and handling to the buyer, using a credit card or a service such as paypal (step 120);
the buyer waits for the delivery of the item (step 130);
when the item arrives (step 140), the buyer inspects the item (step 150) and either: a) is satisfied, which marks the end of a successful transaction (160), or b) files a complaint with the system (step 170) to start the dispute resolution process (step 180).

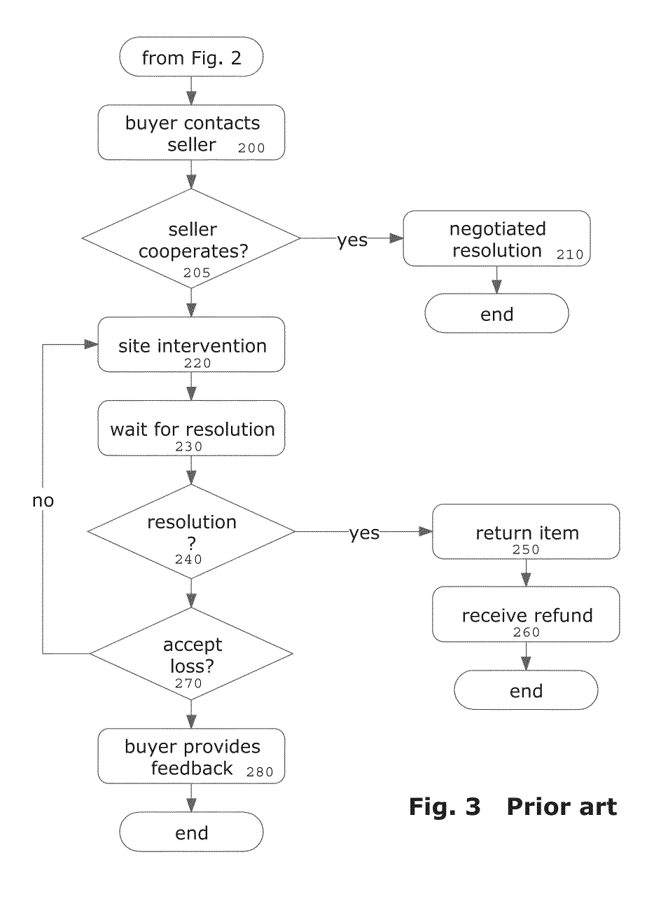

FIG. 3 shows a typical prior art dispute resolution process. The buyer is required to initially contact the seller and try to resolve the dispute on his/her own (step 200). The buyer must then determine whether the seller will be cooperative (step 205). If the seller is cooperative or the matter in dispute obvious or minor, the issue may be quickly resolved (step 210).

Unfortunately, cooperation and quick resolution by the seller often does not occur, because the seller is already paid in full and reluctant to take the item back and grant a refund. It also happens that the seller does not even respond to the contact attempts by the buyer. The only leverage the buyer at that point is the feedback that the buyer can provide regarding the seller. Reputable sellers try to maintain a good track record and therefore are generally responsive to the complaints of buyers. However, not every seller falls in that category, and the risk of having to deal with a seller in that category is high, especially if the seller is not an established vendor but rather an individual performing an occasional transaction.

If the attempts of the buyer to get resolution fail, the site can intervene and contact the seller (step 220). The buyer waits (step 230), in some cases for weeks, while the site attempts to resolve the situation. The site also has very limited leverage, because payment has already been made in full. Eventually, the site determines whether it can achieve resolution (step 240). If a resolution is reached, the item is returned (step 250) and a refund is issued (step 260). If no resolution is reached, the buyer must decide whether to accept the loss (step 270). If so, they buyer may provide negative feedback about the seller (step 280). Alternatively he/she can file an appeal with the site, which extends the process even further.

A major disadvantage of this resolution method is that it can be very lengthy and time-consuming, and puts the buyer at a great disadvantage, because the buyer may have to order the needed item again from another vendor, without even knowing if the dispute for the item already purchased will be resolved or not, and when. The seller during this whole process is under no time pressure to get the dispute resolved because full payment has already been made.

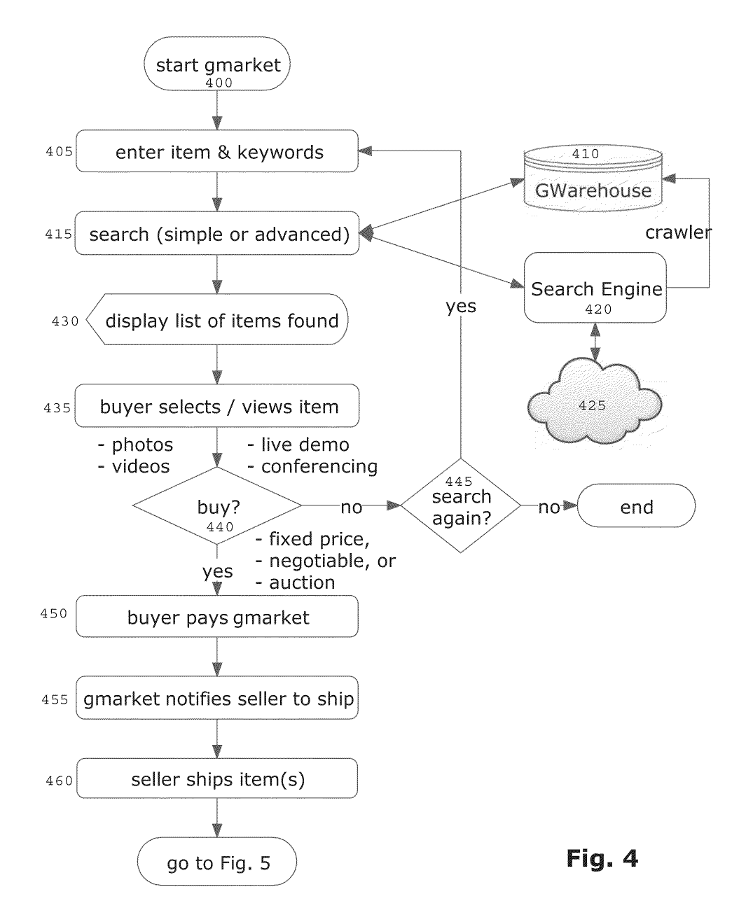

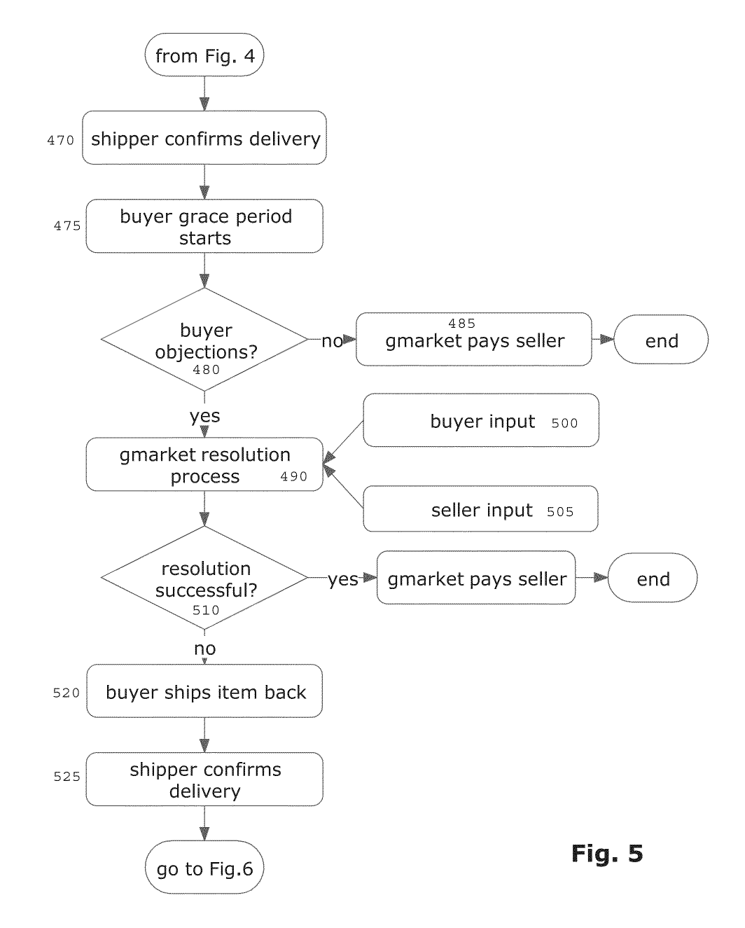

FIGS. 4-6 illustrate an embodiment of an alternative method and system for execution of a transaction via electronic commerce. In step 400, the buyer logs into a system web site (referred to hereinafter as gmarket, short for global market). The buyer locates a desired item, such as be entering a search term descriptive of the desired item (step 405). In addition, the buyer may enter additional keywords that can accelerate and/or focus the search (such as synonyms, characteristics or properties of the item, size/dimensions, capacity, color, item age, material, geographic location, price range, features desired, features undesired, country of origin, etc.). Entering such additional keywords can facilitate creating a match with the items being searched.

The e-commerce system embodiment of FIG. 4 can be utilized to create a global virtual warehouse (the GWarehouse) where almost any type of item worldwide can be found. Therefore, in the embodiment of FIG. 4, generally no listing fees will be charged and items can be “GWarehoused” (i.e. maintained as a listing) for free indefinitely (a periodic email reminder, typically once a year, will ask sellers to confirm that the item is still available and for sale to keep inventory fresh and relevant, but generally no extension fees will be charged). The GWarehouse will generally exist as an organized and indexed database 410 that can exist in a physical location and/or in the cloud, or as a set of linked databases that can exist in a physical location and/or in the cloud. The GWarehouse can be segmented by countries or regions to facilitate searches, e.g. by starting searches in the more likely locations. While the embodiment of FIG. 4 contemplates no listing fees, it is understood that alternative economic models could be employed in other embodiments.

As the next step in FIG. 4, a search for the item is conducted (step 415). The search can be a simple search (with or without keywords) or it can be an advanced search based on specific fields of the GWarehouse database. The advanced search can be entered by the user by filling out a table with the possible search fields, or by providing a special search command language with a syntax that allows logical operators (such as for instance the syntax provided by the USPTO for searches of the USPTO database).

In order to rapidly populate and grow the GWarehouse, the embodiment of FIG. 4 includes a Search Engine 420 that searches the Internet 425 with crawler software for the same items being searched by buyers, in order to find sources for those items and automatically invite those sites to list in GMarket. This is analogous to the crawler software used in search engines to collect information that will accelerate searches, but in this case it is focused on the items that buyers are looking for in their searches. The use of this crawler software will allow fast and inexpensive growth of the GWarehouse.

The user's search in step 415 returns a list of responsive items, which is displayed to the user (step 430). The buyer then selects and views the desired item (step 435). Preferably, GMarket provides not only the traditional photos of the item, but also other communication options for conveying information about the item, such as multiple photos from many sides and angles and even videos that the seller can post in the site using the site supported recording devices which can include a digital camera, a video recorder, the built-in camera of a laptop, the camera of a tablet computer, the built-in camera of a phone or other portable or stationary recording devices.

A further feature of the illustrated embodiment that may be important to many buyers is the live demo, which allows a seller to walk around the item with a camera, recorder, phone, tablet, laptop or other device capable of capturing audio and video, to demonstrate the product from different sides and angles, possibly in operation to prove its working condition. Also, communication facilities such as messaging, instant messaging, email relaying, audio conferencing, video conferencing and other communication facilities can be provided by the site to facilitate the transaction.

Thus, the system illustrated in FIG. 4 addresses the problem of insufficient or inadequate disclosure with several different facilities based on advanced communications technologies. These facilities can be particularly important because they can create the level of comfort and trust needed for a transaction between parties still unknown to each other. In many cases this method also can create a record that can be used to prove that the part displayed and the part shipped are actually the same.

Next, the buyer makes the buying decision (step 440). If negative, the buyer can choose whether to start a new search (step 445). If positive, the buyer pays GMarket the full item price plus shipping and handling as applicable (step 450). GMarket confirms to seller that full payment has been made and the seller should ship the item to the buyer (step 455). The seller ships the item (step 460).

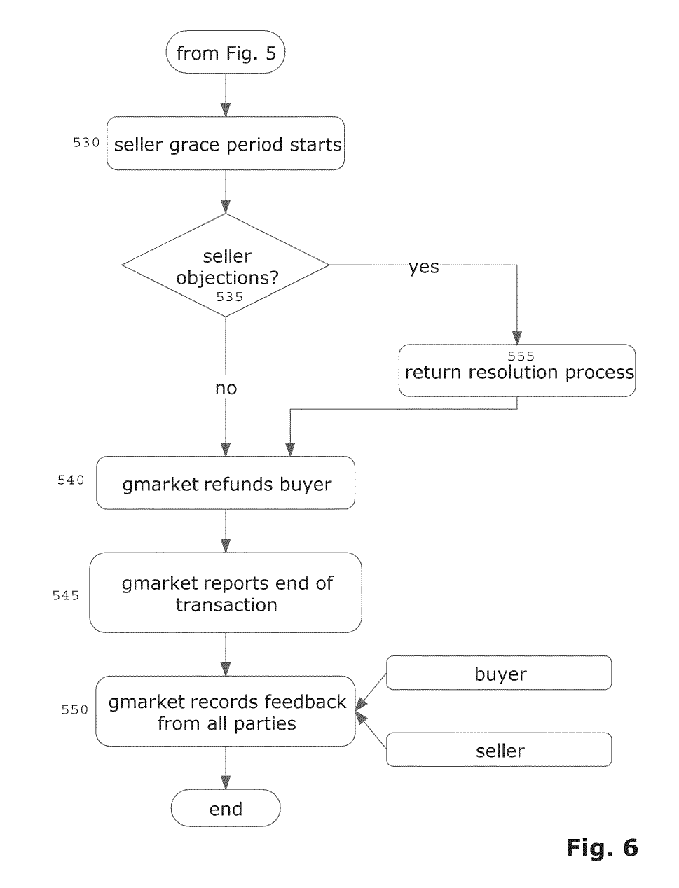

In FIG. 5, when the item arrives, the shipper confirms delivery to GMarket (step 470). A grace period is provided for the buyer to report problems with the transaction (step 475). In the embodiment of FIG. 5, that grace period is triggered by the seller's confirmation to the GMarket system of delivery. In some embodiments, the length of this grace period may vary based on factors associated with the transaction and/or the parties involved. For example, the duration of the grace period may be dependent on the dollar amount of the purchase and other factors. Typically, the determination of grace period will be part of the terms and conditions agreed by all parties at the time the purchase is made. In a typical embodiment, for a small item, the grace period may be approximately 2 business days.

A determination is then made as to whether a buyer objects to the transaction before expiration of the grace period (step 480). If there are no buyer objections within the grace period, GMarket pays the seller (step 485).

If there are objections within the grace period, the GMarket resolution process starts (step 490) by GMarket receiving input from both buyer (step 500) and the seller (step 505). Preferably, the GMarket site provides communication facilities to encourage interaction between the buyer and seller to help the parties explain and understand any objections and potential resolution. For example, being able to show the product and explain the objections in a video conference can facilitate a quick resolution. In addition to video conferencing, the GMarket site may enable exchange of photographs, video clips and written communications between the parties, in order to explain and discuss any concerns with the product or transaction.

Ultimately, a determination is made within the GMarket site or system as to whether the buyer will keep the merchandise (step 510). This decision may be made by agreement of the parties. Alternatively, GMarket may act as an arbitrator to determine whether the buyer will be forced to keep merchandise or whether the buyer will be permitted to ship merchandise back. The arbitration decision may be driven by automated rules, or may include subjective determinations based on the information submitted by the parties during the resolution process 490.

If the buyer will keep the merchandise, GMarket pays the seller (step 515). Otherwise, the buyer ships the item back to the seller (step 520). Delivery of the item back to the seller is confirmed in step 525.

As soon as the item arrives back at the seller's location, the seller's grace period starts (step 530). The seller's grace period provides a (preferably short) period of time during which the seller can report any objections regarding the returned item. A determination is then made as to whether the seller indicates objections to the returned merchandise before expiration of the seller's grace period (step 535). If not, GMarket refunds the buyer (step 540), closes the transaction (step 545) and records the feedback from the buyer and seller (step 550). If so, a return resolution process is initiated (step 555) during which the GMarket service provider determines whether the returned merchandise satisfies criteria for a refund. If so, operation proceeds towards issuance of a refund to the buyer (step 540). If not, the transaction is ended without refund (step 545).

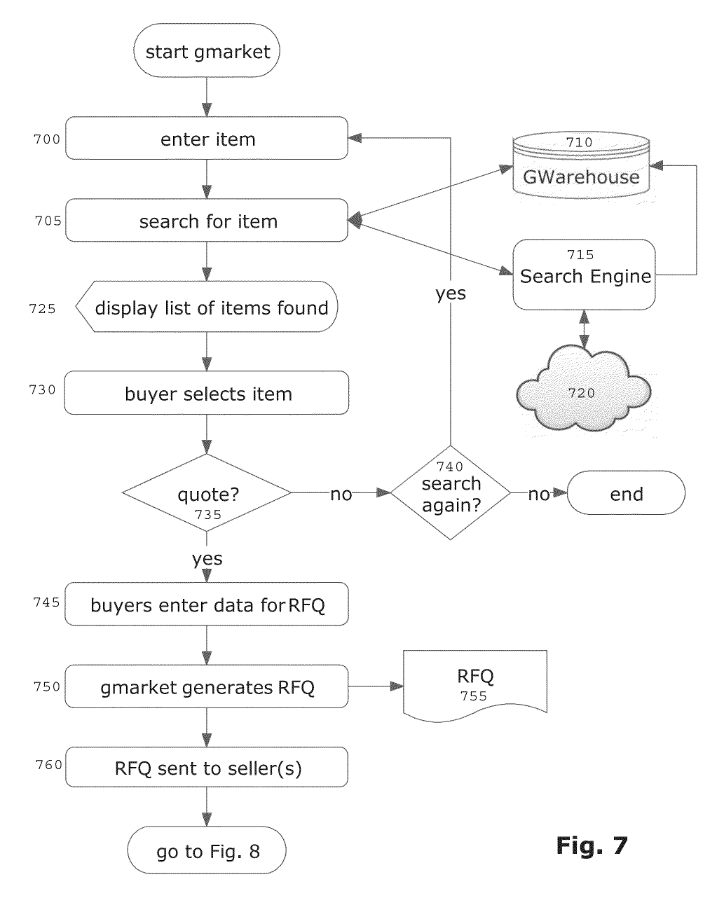

The transaction described in FIGS. 4 through 6 reflects an embodiment that may be preferably used in a transaction between individuals or between an individual and a dealer. For a commercial transaction (typically between two companies), a modified implementation may be preferable. FIGS. 7 through 10 illustrate an alternative process and system that may be useful to conduct such commercial transactions. In some embodiments, users may be offered a choice as to whether they will use the process of FIGS. 4-6, or the alternative commercial process of FIGS. 7-10, for a given transaction. The commercial process includes the ability to accept and grant credit terms.

FIG. 7 illustrates a process for performing a commercial transaction. The initial portions of the process are analogous to initial steps in FIG. 4, previously described. The buyer enters information associated with a desired item (step 700), and a search is conducted (step 705) within GWarehouse database 710. GWarehouse database 710 can optionally be populated through operations including the operation of search engine 715 operating on Internet 720. Responsive items are displayed to the buyer (step 725), and the buyer selects a desired item (step 730).

Once the buyer has viewed and selected an item, the buyer determines whether to request a quote on the selected item (step 735). If not, the buyer decides whether to run another search or terminate the potential transaction (step 740). If so, the buyer enters data required to prepare a Request for Quote (RFQ) (step 745). The GMarket system operates (step 750) to generate a standardized RFQ document 755. RFQ 755 is sent to one or more sellers (step 760).

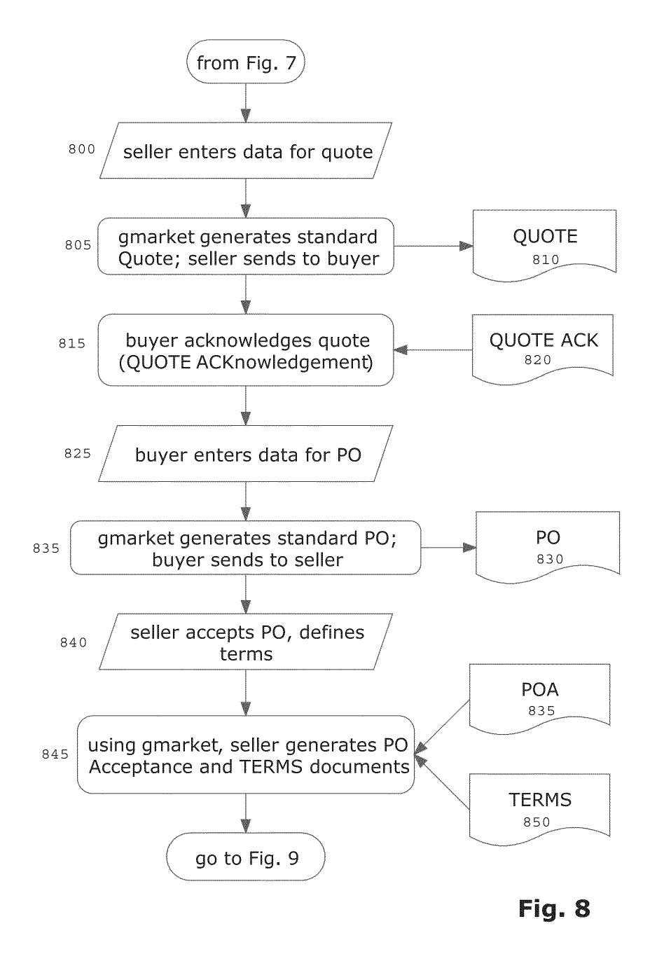

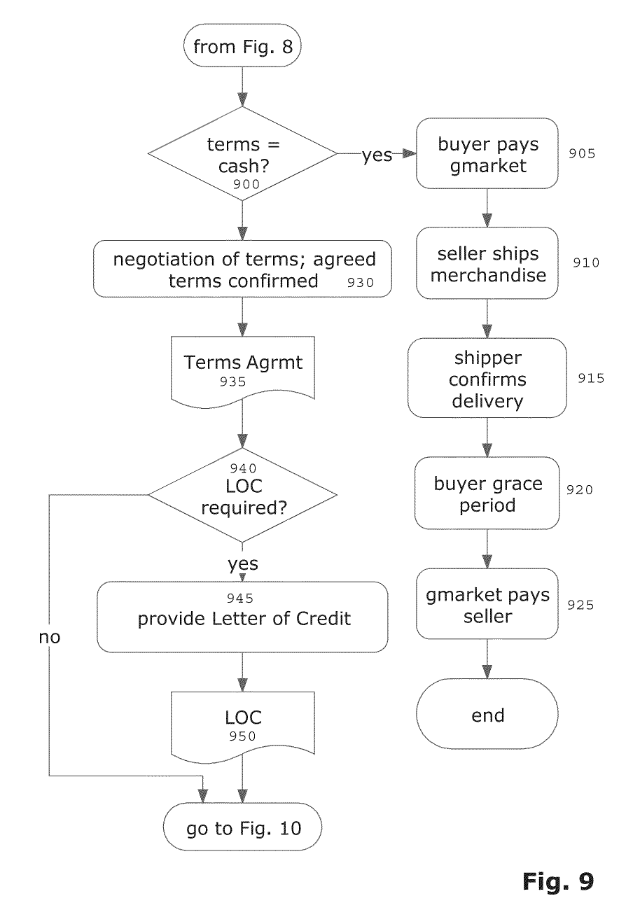

FIG. 8 shows the continuation of a GMarket commercial process. In step 800, one or more sellers respond to RFQ 755 by entering data for a quote (step 800). The GMarket system utilizes information entered in step 800 to prepare standard commercial transaction documents, such as the Quote (QUOTE 810), the Quote Acknowledgement (QUOTE ACK 820), the Purchase Order (PO 830), the Purchase Order Acceptance (POA 835) and the terms document (TERMS 850). Specifically, QUOTE 810 is generated in step 805 and transmitted to the buyer. In step 815, QUOTE ACK 820 is generated in response to the buyer's acknowledgement of QUOTE 810. The buyer then enters purchase order data into the GMarket system (step 825). The GMarket system then generates PO 830 and transmits that document to the seller (step 835). In step 840, the seller accepts PO 830 and defines transaction terms. The GMarket system is then utilized by the seller to generate POA 835 and TERMS 850. Preferably, the commercial transaction documents are standardized to enable an efficient and largely automated generation and processing of these transaction milestones.

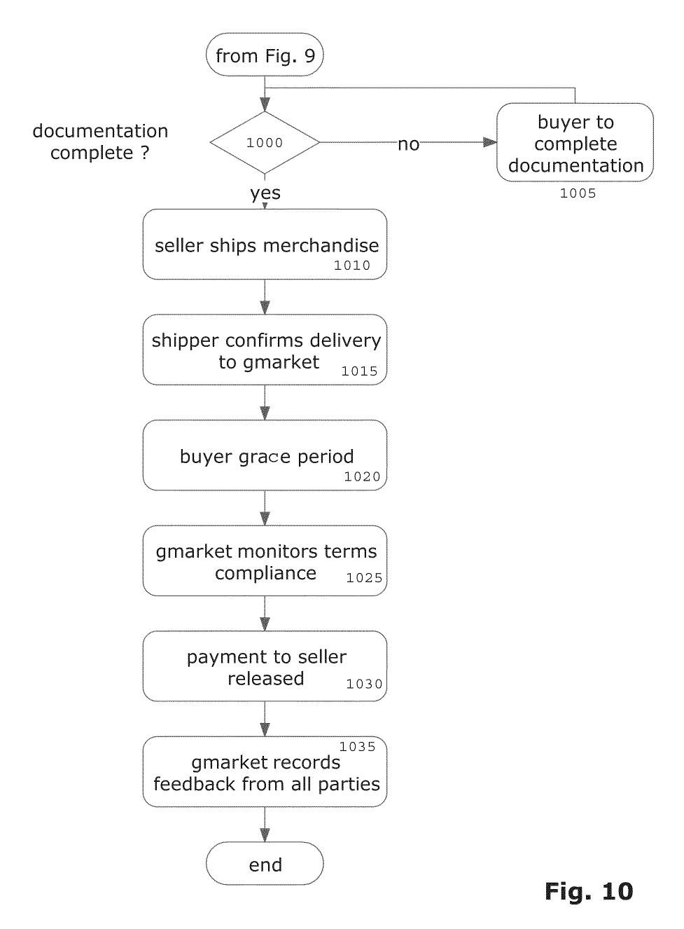

FIG. 9 illustrates a continuation of the process of FIG. 8, in which the transaction can follow one of two paths, depending on whether the terms will be cash or credit (step 900):

If the terms are cash, the right hand path is followed with the same steps described in connection with the embodiment of FIGS. 4-6, which include payment to GMarket (step 905), shipping to buyer (step 910), delivery confirmation by shipper (step 915), grace period(s) (step 920) and payment to seller by GMarket (step 925). Preferably, if disputes arise, dispute resolution processes described in connection with the embodiment of FIGS. 4-6 can also be employed.

If the terms are credit, then credit terms can be negotiated and agreed upon between the parties, preferably facilitated through the GMarket web site (step 930). A Terms Agreement 935 is generated. In step 940, a determination is made as to whether a Letter of Credit (LOC) is required. If so, LOC 950 is provided by a financial institution (step 945).

In step 1000 (FIG. 10), a determination is made as to whether the transaction documentation is complete. If not, the buyer is required to complete the documentation (step 1005). However, if the documentation is complete, then the seller ships the merchandise (step 1010). Delivery of the merchandise is confirmed with GMarket (step 1015), which initiates a buyer grace period (step 1020). During the buyer grace period, the GMarket system monitors compliance with the terms of the transaction, which may include a period for buyer inspection and approval and/or other terms conditioning acceptance of the merchandise and completion of the transaction. If the transaction terms are satisfied, payment is released to the seller (step 1030), and the GMarket system provides an opportunity for all parties to record feedback regarding the transaction (step 1035).

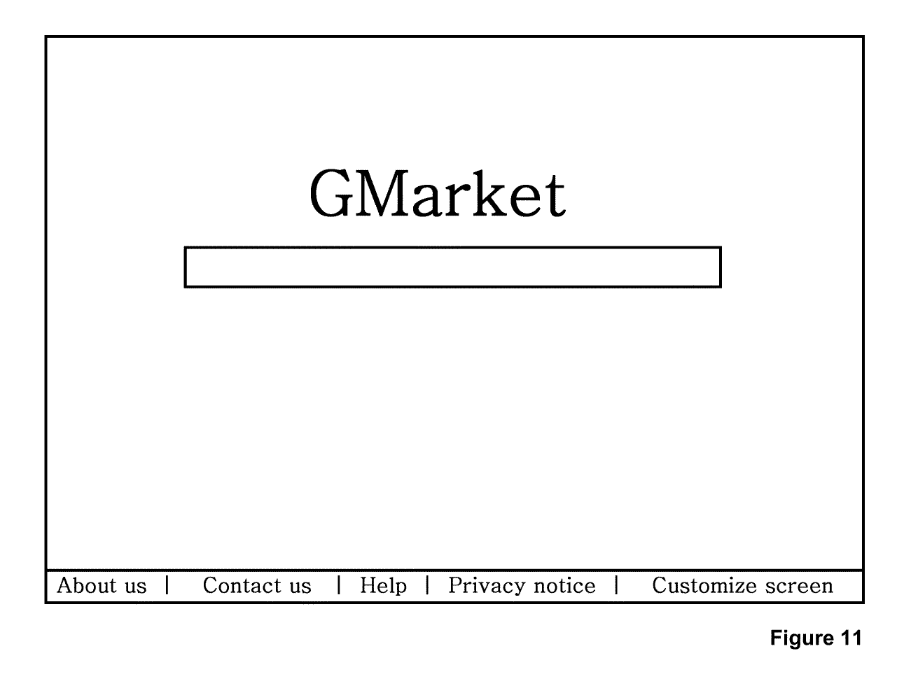

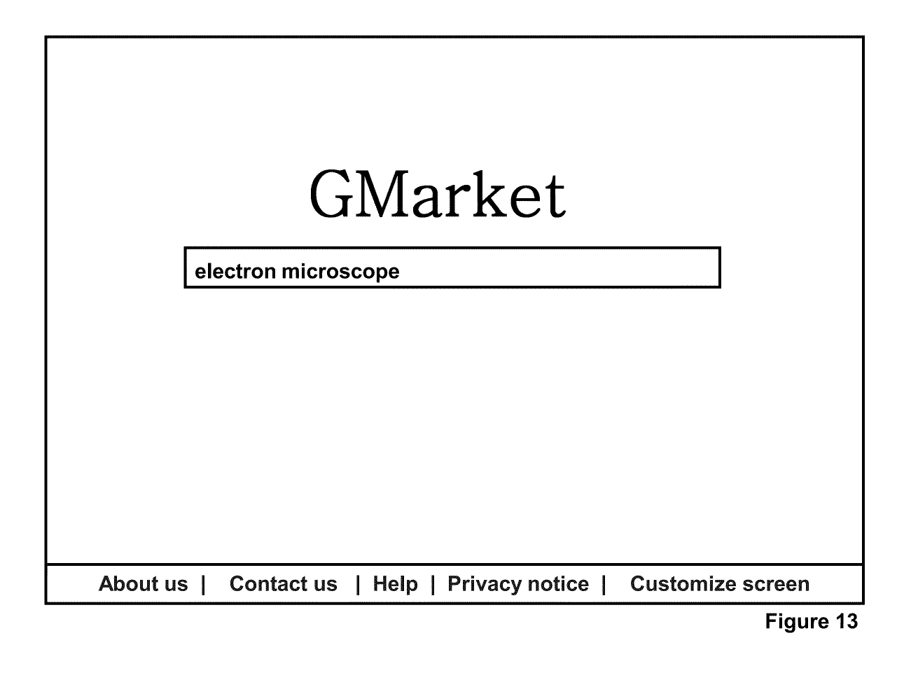

FIGS. 11-33 illustrate an embodiment of the software and user interface implementation of the previously described method and system. Specifically, FIG. 11 and FIG. 13 show a search interface usable in step 405 (FIG. 4).

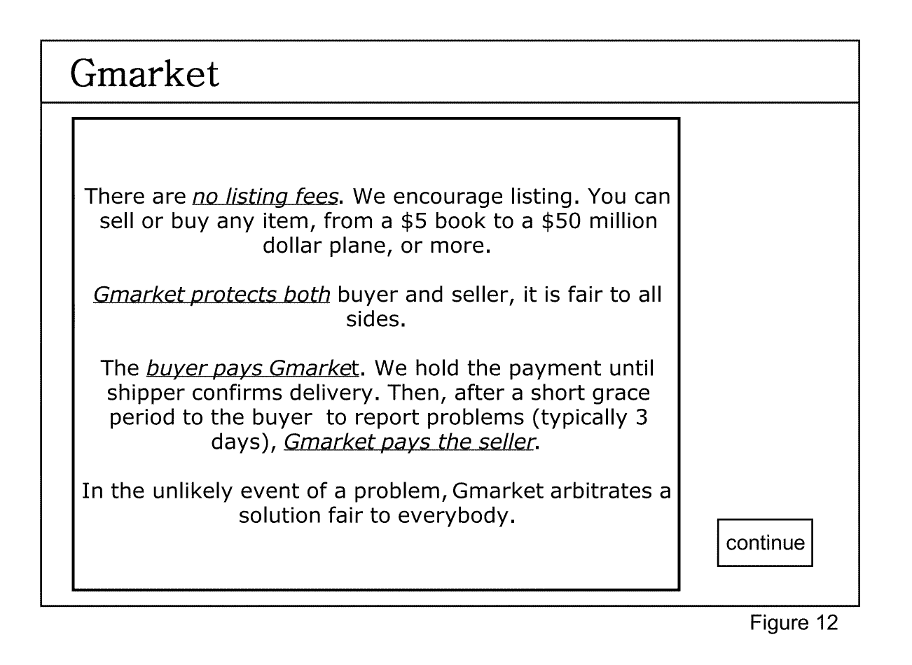

FIG. 12 illustrates an instructional screen that can be made available to users to explain the operation of the system and method.

FIG. 13 shows that a potential buyer is using the search field to enter a product he/she is looking for, in this example an electron microscope.

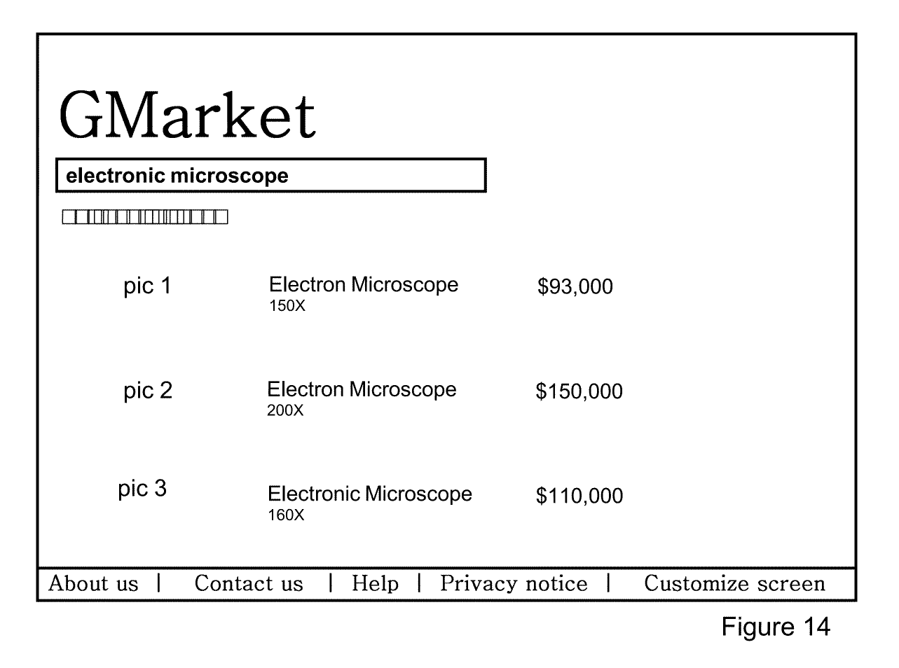

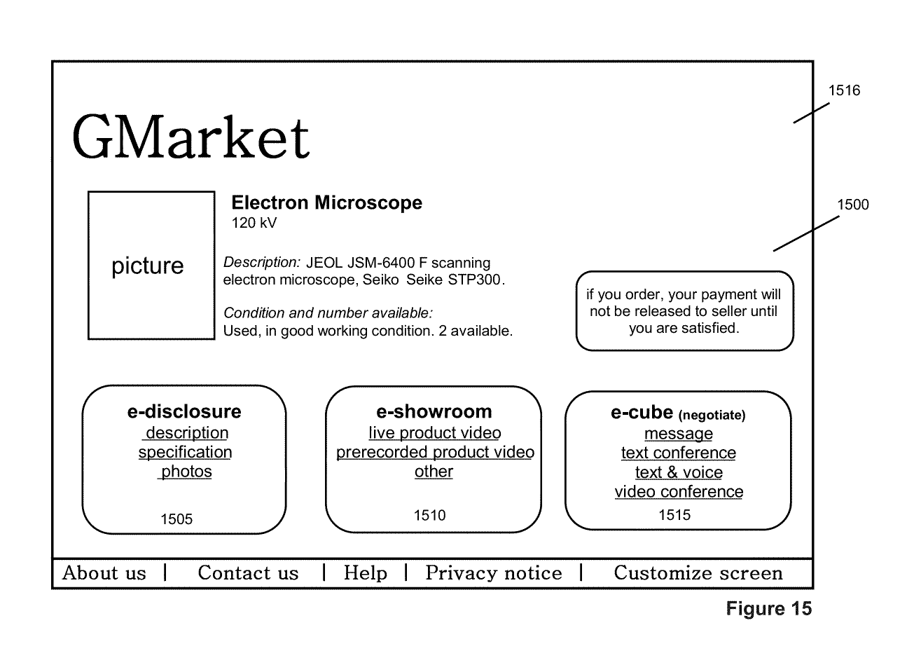

FIG. 14 illustrates a search result display generated during step 430.

FIG. 15 is a detailed view of an item returned within the search result of FIG. 14, which includes “order” button 1500 operable for selection of an item in step 435. FIG. 15 further includes access to multiple communication facilities to convey comprehensive and detailed information about the selected item, such as e-disclosure 1505, e-showroom 1510, and e-cube 1515 to enable live audiovisual communication between the parties, and/or email communication. These key communication facilities are described in more detail below.

The embodiment of FIG. 15 provides several different facilities in order to, amongst other things, address the problem of insufficient or inadequate disclosure of information about items for sale. While other ecommerce systems rely on text description and static photographs to describe the items, such description can be insufficient and in some cases potentially misleading, because the seller may display only photographs from favorable sides or angles (scratches, dents and defects may not be shown). An important facility to address this issue is the e-disclosure 1505, which is based on a standardized catalog of requirements for posting an item for sale through the system. E-disclosure 1505 specifies the minimum amount and the type of information that a seller should provide when posting an item for sale. E-disclosure 1505 is a minimum, but it doesn't limit the sales creativity of the seller, because the seller can post additional information above and beyond what e-disclosure 1505 prescribes as a minimum for full and accurate disclosure about the product. The advantage of the e-disclosure facility is that the buyer will have a clear picture of the product presented in a standardized way, and with little room for an incomplete or misleading representation of the item. It will also create a record that will discourage any future potential dispute and simplify a possible dispute resolution process. As an example, the e-disclosure for photographs of the items may prescribe a frontal view, two side views, a rear view, a bottom view and two frontal angle views. For items that can be opened and closed, a view of each position will be required by the e-disclosure too. The objective is to create a set of views that apply to all products, so that buyers can see at least some standard views for all the products, which facilitates comparing across vendors and products. E-disclosure 1505 also makes it hard to hide any defects by showing only favorable pictures.

As can be further seen in FIG. 15, e-disclosure 1505 includes a product description, a specification and a set of standardized photos. While other systems may provide some of these elements, but they typically do so in a non-standardized way that leaves it up to the seller to decide what and how to disclose, resulting in a confusing array of different disclosure styles and methods and making it very hard to compare different offerings. By contrast, e-disclosure 1505 creates a minimum standard level of disclosure, generating clarity and comparability.

E-disclosure 1505 can be an important feature in order to provide accurate and truthful product disclosure. However, there are many cases when the e-disclosure alone may not be enough and the buyer may need additional information (or the seller may want to provide additional information to induce the buyer to go ahead with the transaction). For those cases, the illustrated embodiment provides an innovative facility called the e-showroom 1510, which addresses those problems using advanced communications technology. E-showroom 1510 is a virtual meeting room created by the system at the request of either the buyer or the seller. It allows the buyer and the seller to communicate using instant messages (text), voice (VOIP) and video streaming. In an exemplary implementation of e-showroom 1510, the seller is able to place the product on a table and demonstrate its appearance by streaming video from many different angles (achieved with a digital camera, a tablet, a phone with a camera, or a laptop with a camera). The buyer can ask questions and ask the seller to zoom in or to show another angle, etc. This is a powerful sales tool, and can be used not only to show the outside appearance of an object, but also to demonstrate its functionality. For instance, the seller of a TV set can show that the item is in good external condition and then he can also turn it on while the buyer watches, and show the picture and sound quality. For sellers with a high volume of sales it would be advantageous to pre-record such a video, so that it can be made available to many potential buyers without having to conduct a live demo for each one of them, which would be time-consuming. The e-showroom facility 1510 can be used either in live mode or in pre-recorded mode. After viewing a pre-recorded product demonstration, the buyer will be offered the option to call the seller to the e-showroom to answer any remaining questions.

Demonstrations within e-showroom 1510 are not limited to a table of course. Depending on the nature and size of the item, the e-showroom may be indoors or outdoors. For example, a vehicle for sale can be demonstrated and inspected in great detail together by seller and buyer indoors (such as a garage or barn) or outdoors (such as parking lot or a driveway).

FIG. 15 also shows another key facility called the e-cube 1515. The mission of this facility is to encourage, promote and facilitate active communication and even negotiation between buyer and seller, thereby making the illustrated embodiment a social ecommerce system. This is totally different from other ecommerce systems, which typically discourage, limit or try to control direct communications between buyer and seller, who are warned not to communicate outside the website and little support is provided to help them communicate directly. This is largely based on the fear that the buyer and seller may strike a deal on their own, bypassing the system and thus avoiding the fees due the system. This is to some extent understandable, because a prior art system provides little or no additional value once the parties are connected and they don't need the system to complete the transaction. That is very different from the illustrated system, where the system is the payment holder and the guarantor and enabler of the whole transaction. The system provides substantial value even after the buyer and the seller have connected with each other, because they still need the system to complete their transaction and disburse the payment. Therefore the new system can afford to encourage communications rather than trying to limit and control it. Encouraging communications has the big advantage that transactions are more likely to actually happen, because communications promote trust and willingness to trade. Also, if a transaction does happen, it is more likely to be a successful one and not ever give rise to a dispute and possible mediation or return/refund, because the parties have clarified things much better and the probability of a misunderstanding or misfit is substantially reduced. Finally, if there is a dispute, expanded communications will provide a better record on which a dispute arbiter can evaluate the parties' positions.

To encourage communications, a facility called the e-cubicle (for short, the e-cube) is provided. The e-cube is a virtual meeting area automatically created by the system for each potential transaction when a buyer and a seller choose to communicate. E-cube 1515 (FIG. 15) is equipped with text, voice (VOIP) and video capabilities, so that the buyer and seller can communicate freely using any of these tools. The communications in e-cube 1515 can be recorded by the participants by mutual agreement and both will be informed that the recording is taking place. One advantage of recording is to create a record that can be checked later if something was not clear. It will also be useful if there is a dispute later. The e-cube is an area where buyer and seller are encouraged to communicate and negotiate. This may be a significant difference with respect to other ecommerce systems, where negotiation is discouraged and almost non-existent. The illustrated social ecommerce system pursues and encourages negotiation by providing the right technology tools to do so, with the goal that trade flourishes as a result.

Another facility that can also contribute to a smooth transaction is e-price 1516. The e-price is a feature in the system that forces sellers to disclose the price of an item in an unambiguous way. In many prior art systems, it may be possible for a seller to mislead a buyer by charging a relatively low price for the item, and then at checkout adding a large “shipping and handling” charge. E-price facility 1516 prevents that, by disclosing the total price and breaking total price down into 3 categories: a) item price, b) shipping and c) handling. Preferably, the categories “shipping” and “handling” cannot be merged into one, they are disclosed separately. Further, a shipping estimate from a standard shipper such as UPS is also provided as a reference for the buyer. As a result, the buyer sees the total price, can compare with other vendors and can judge if the handling charge is reasonable or not. While some vendors may not like this feature, because it makes it very difficult to “trick” the buyer, most vendors will appreciate this feature, because full disclosure and avoidance of price shifting and avoidance of misleading information attracts more buyers and creates repeat business.

The facilities and systems used in the illustrated embodiment can create a great amount information and transparency about a product and transaction. An underlying philosophy is that the best dispute resolution method is the one that avoids disputes in the first place, and these innovative facilities can do that in unprecedented ways. Combinations of facilities such as e-price, e-standards, e-cube and e-showroom can eliminate many possible disputes.

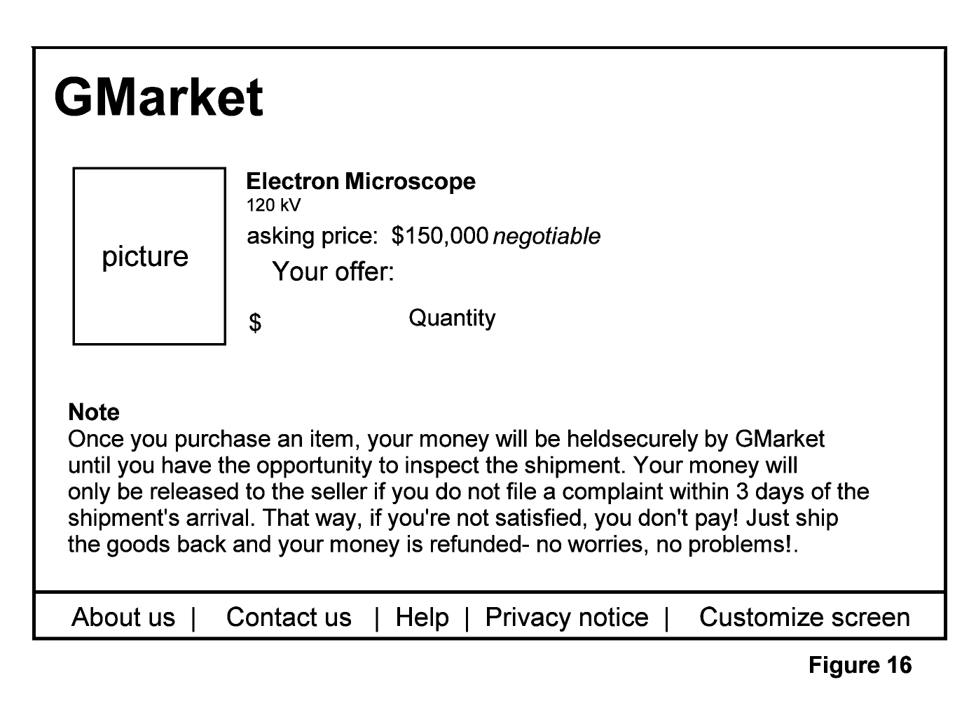

FIG. 16 illustrates an interface through which a user can submit a bid for an item (step 440). This is the next step after obtaining a wealth of relevant and well-organized information through facilities such as e-disclosure 1505, e-showroom 1510, e-cube 1515 and e-price 1516.

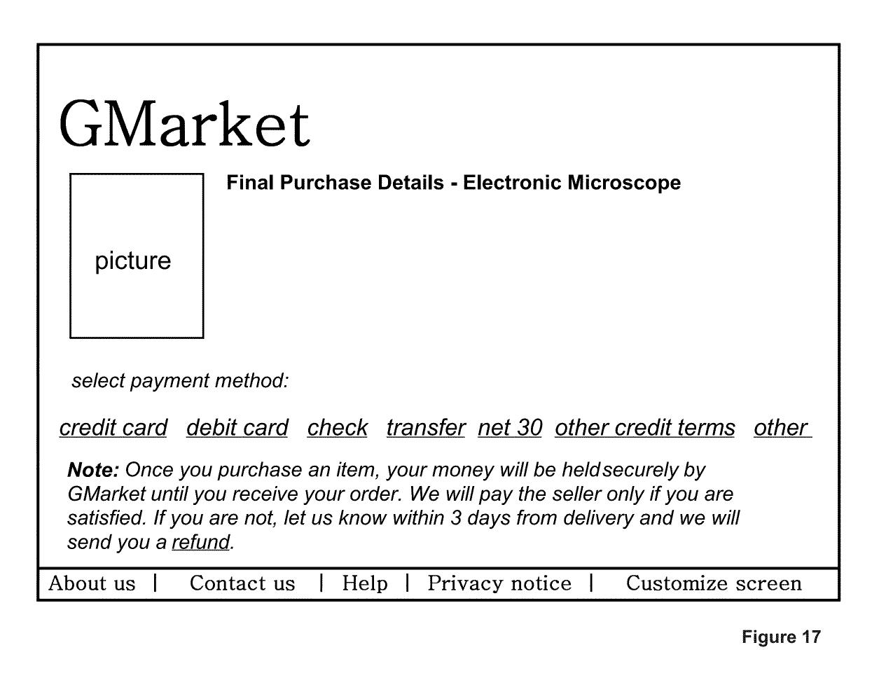

FIG. 17 illustrates a user interface providing confirmation of bid acceptance.

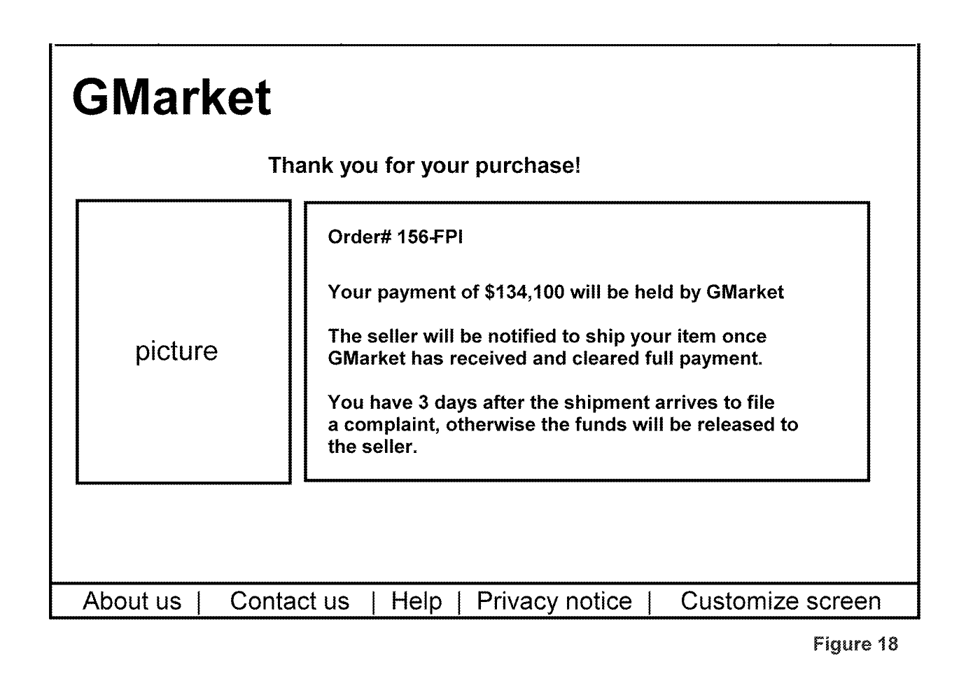

FIG. 18 illustrates confirmation of a buyer's payment following step 450.

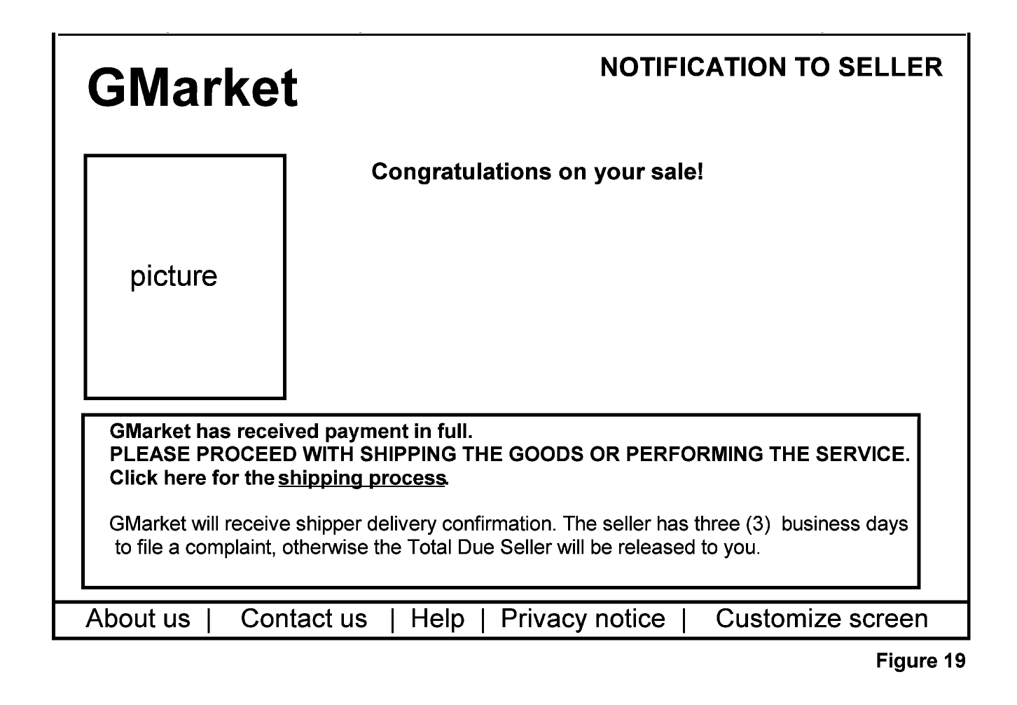

FIG. 19 illustrates notice to a seller that an item has been sold and request for shipment in connection with step 455.

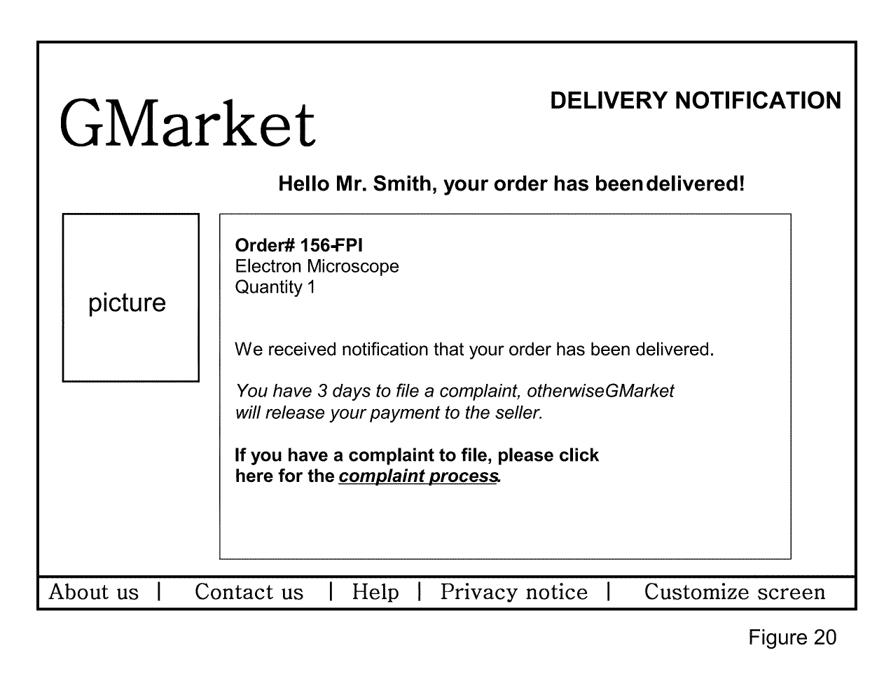

FIG. 20 provides a notification to the buyer than an order has been delivered (step 470, FIG. 5) and that a buyer's grace period is commencing (step 475).

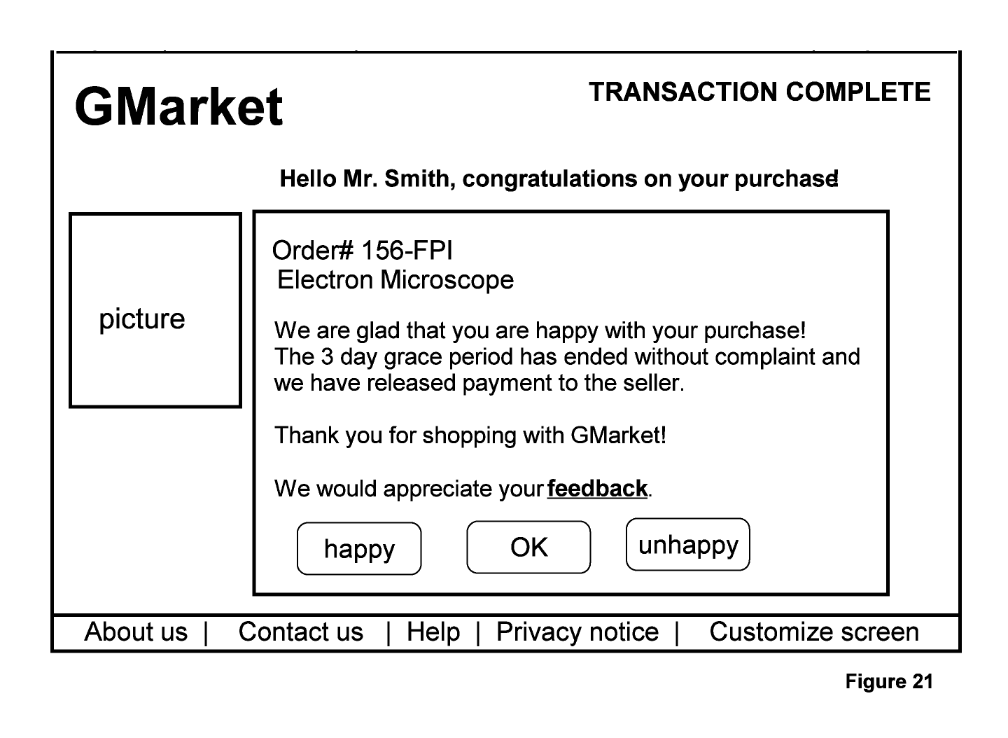

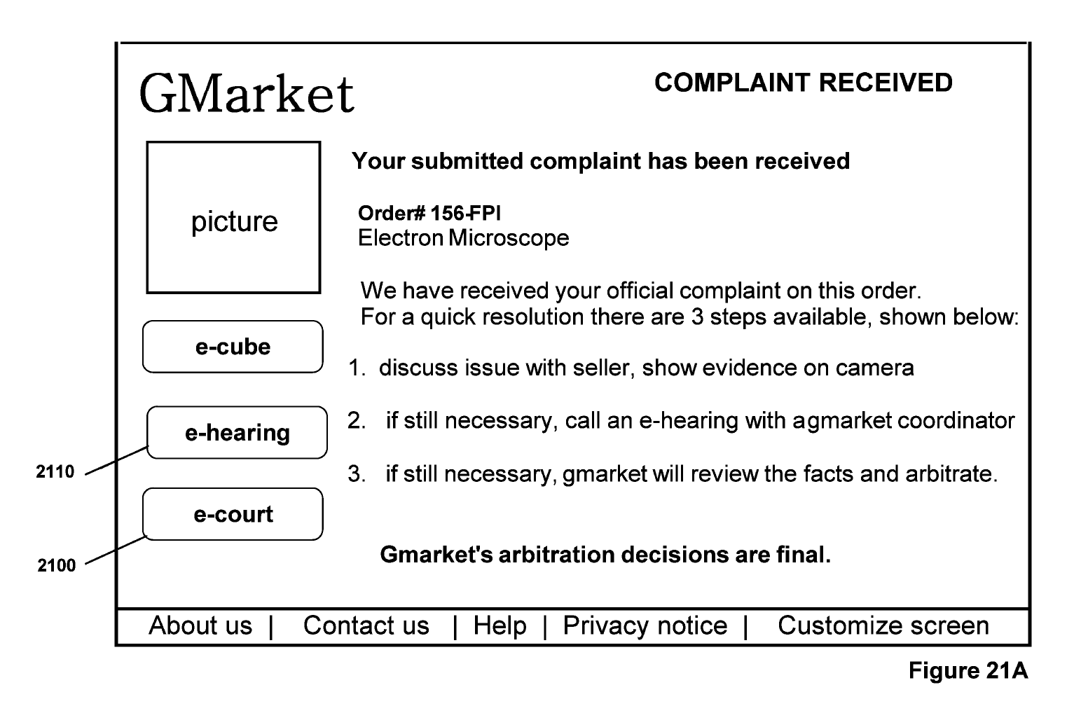

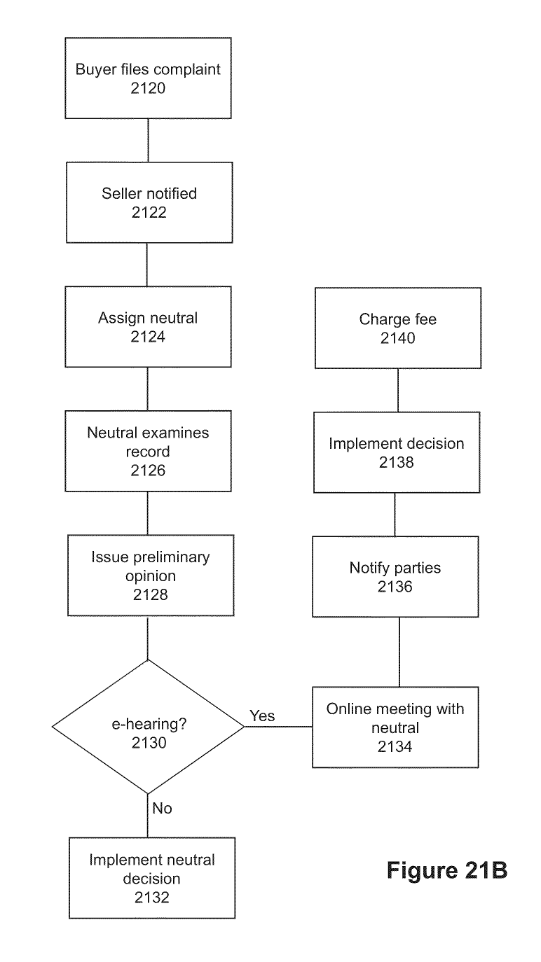

FIG. 21 illustrates a message provided to a buyer if no timely objection is made, upon which payment is released to the seller in step 485.

FIG. 21A illustrates a user interface for a resolution system for disputes between seller and buyer, in accordance with another aspect of the illustrated system. The system provides key facilities for such a resolution process, which are further described below.

For those cases where a dispute may still arise, despite all the free flow of information and communication provided by the system prior to the transaction, the system provides another facility: e-court 2100. E-court 2100 provides a forum in which parties can request resolution of complaints about a transaction. E-court 2100 may include the services of a third party mediator, who looks at the complaint and issues a preliminary opinion. If either of the parties is not satisfied with that preliminary opinion, the dissatisfied party can file a request with e-hearing facility 2110. E-hearing facility 2110 provides an online mechanism through which the parties to the transaction can meet with a neutral mediator or arbitrator in a virtual hearing room, typically equipped with text chat, audio conferencing, video conferencing and document sharing capabilities that allow the parties to efficiently and clearly make their case. The neutral third party acts preferably as an arbitrator and makes a determination, which is then final. Preferably, both buyer and seller have contractually agreed upfront to accept the neutral's decision as final and forego any further steps. The system can charge a fee for the process to discourage superfluous complaints. Preferably, the loser in the arbitration carries the cost, unless the arbitrator decides otherwise based on the merits of the case. The terms neutral, mediator and arbitrator are used interchangeably herein to refer to an individual charged with determining a resolution to a dispute concerning a transaction. It is understood that in various embodiments, the determination of the neutral, arbitrator or mediator can be binding or nonbinding, appealable or not appealable.

FIG. 21B further illustrates an embodiment of a process through which e-court 2100 and e-hearing 2110 can be utilized in a transaction. In step 2120, a buyer selects e-court facility 2100 and files a complaint and supporting information. The seller is notified of the complaint filing and its contents (step 2122). In step 2124, a neutral is assigned to the dispute. It is contemplated that in some embodiments the assigned neutral may be an employee of the company operating the e-commerce site. In other embodiments, a third party neutral may be selected which is unaffiliated with both the parties and the e-commerce site, such as individuals appointed by independent mediation or arbitration organizations.

In any case, the assigned neutral examines the record of the transaction in step 2126. The examination may include the contents of e-disclosure 1505, e-showroom 1510, e-cube 1515, information provided in the complaint during step 2120, and any other information available. The G-Market system may provide a custom portal for system access by the neutral, to facilitate remote examination of information in step 2126. Once the record has been examined, the neutral issues a preliminary opinion regarding resolution of the dispute to the parties (step 2128). In step 2130, the parties are provided with an opportunity to decide whether to accept the preliminary opinion, or pursue an e-hearing. If the parties accept the preliminary opinion, the neutral decision is implemented by the system in step 2132. Depending on the decision, implementation may include requiring buyer acceptance and release of payment to the seller, requiring the seller to accept a return and refunding of the buyer, granting a partial buyer refund in combination with acceptance of the merchandise, or other variations, depending on the nature of the dispute.

If an e-hearing is requested by the parties in step 2130, an online meeting is conducted between the neutral and the parties to the transaction (step 2134). Subsequently, the parties are notified of the neutral decision (step 2136), and the decision is implemented within the G-Market system (step 2138). Finally, the embodiment of FIG. 21B provides for charging of the e-hearing loser with a fee in step 2140, which may partially or fully offset the cost of conducting the dispute resolution.

The embodiment of FIG. 21B illustrates a two-step dispute resolution process, through which a requesting party can trigger an initial determination by a neutral, which initial determination can then be subjected to a dispute resolution process in which both parties actively participate. However, it is understood that alternative embodiments could be readily implemented without departing from the spirit of the present disclosure. For example, in some embodiments, it may be desirable for the initial complaint filing to trigger a dispute resolution process in which both buyer and seller participate before the neutral issues any preliminary opinion at all.

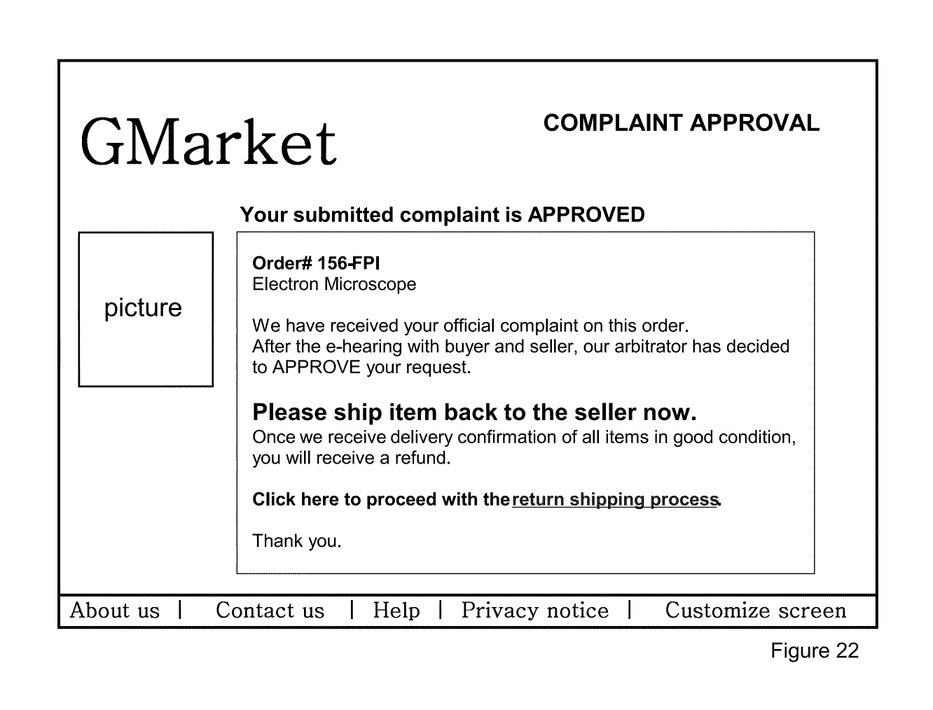

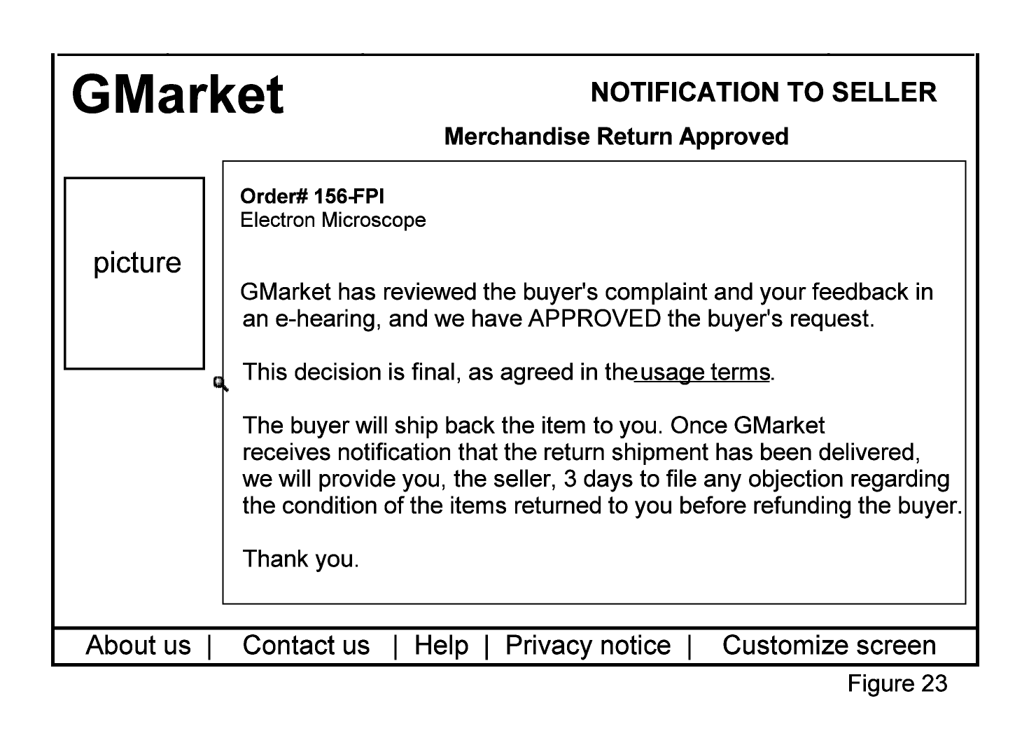

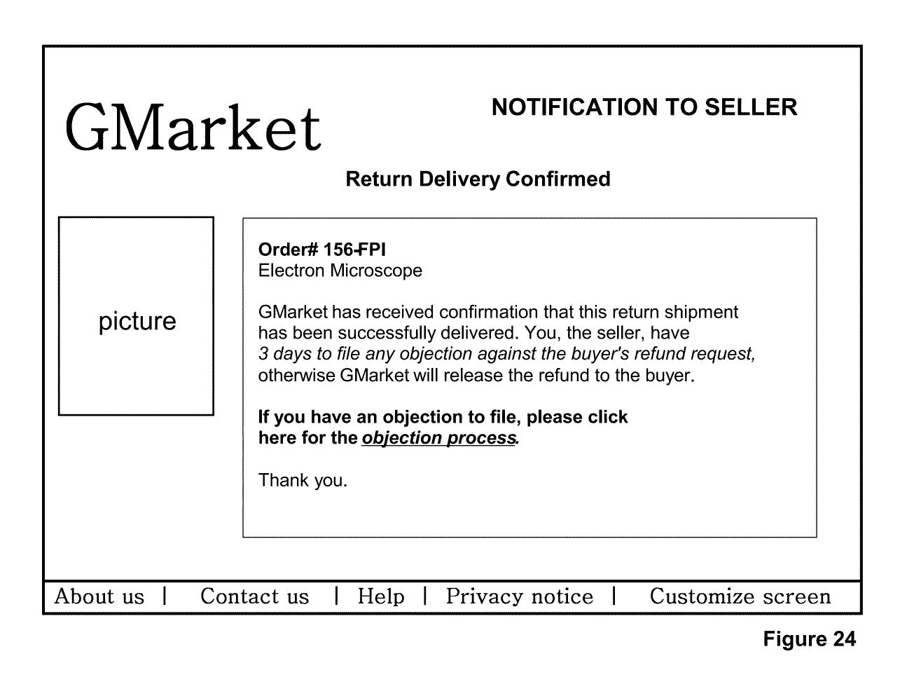

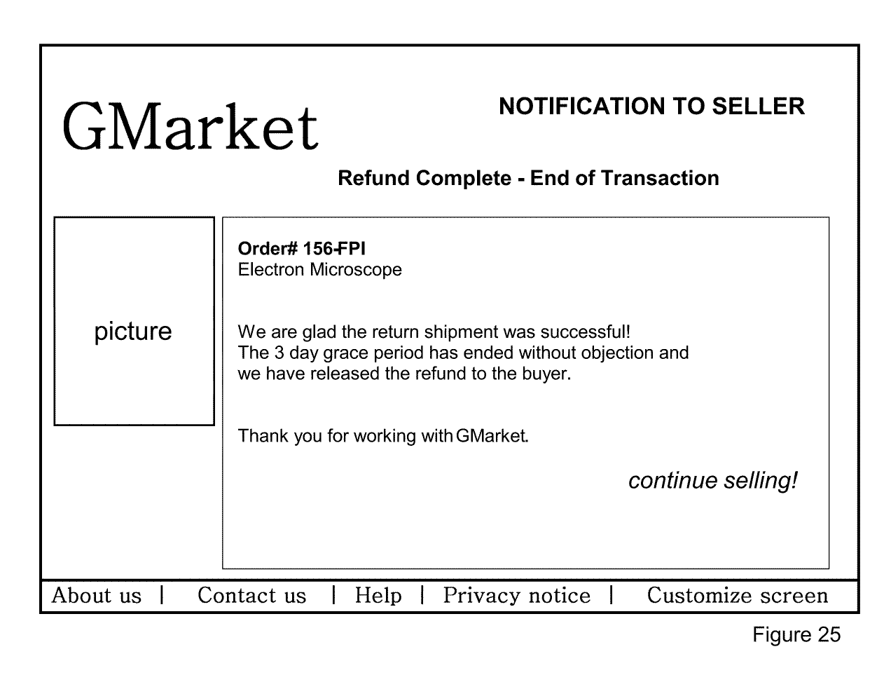

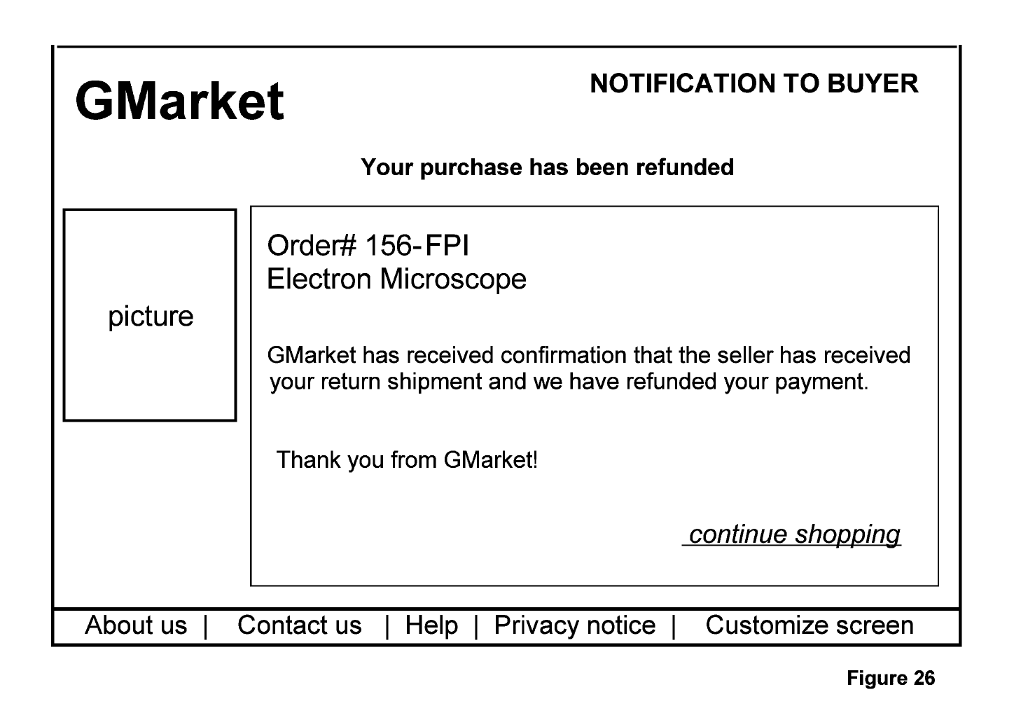

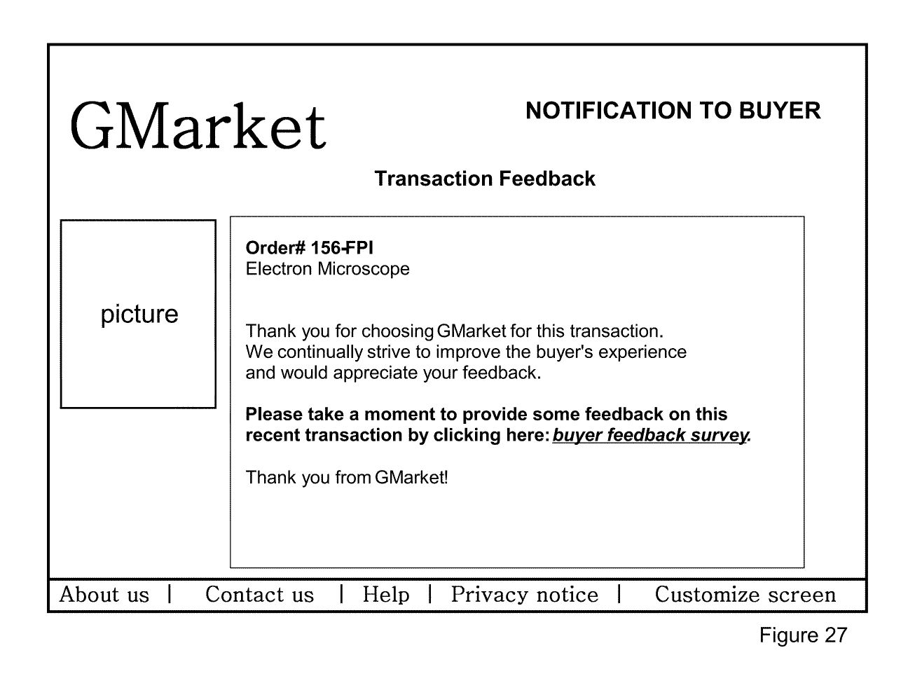

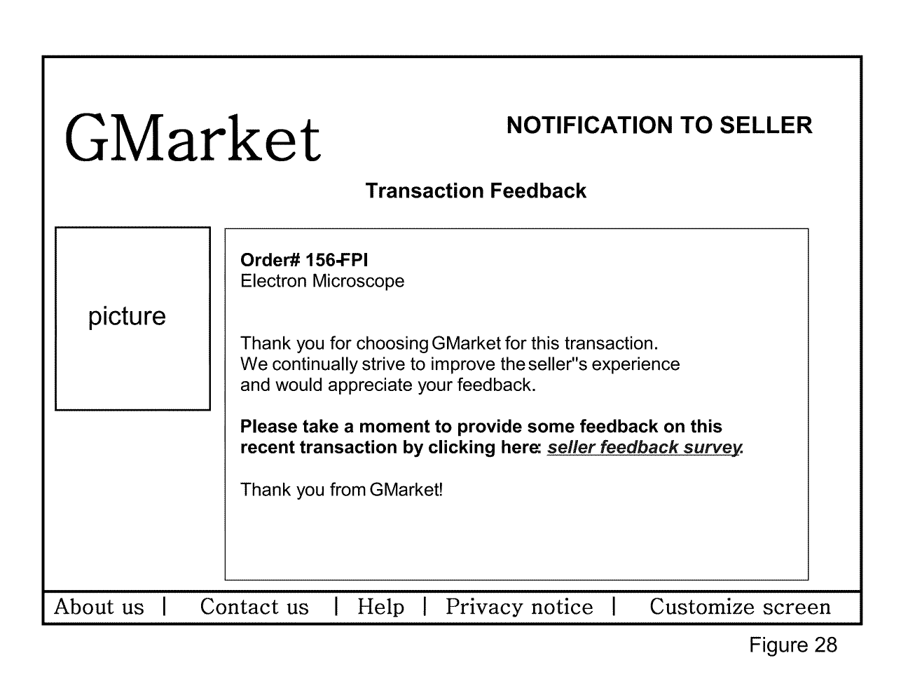

FIG. 22 provides a further exemplary user interface provided to a buyer upon approval of a buyer complaint in step 510, and requesting return shipment of the goods in step 520, while the seller is provided with the notice illustrated in FIG. 23. Upon confirmation of return shipment in step 525, the notice of FIG. 24 is provided to the seller. If the seller does not object to the return shipment in step 535, the notice of FIG. 25 is provided. Upon refund issuance to a buyer in step 540, the notice of FIG. 26 is provided. The user interface of FIG. 27 provides an opportunity for submission of buyer feedback in step 550, while the user interface illustrated in FIG. 28 provides an opportunity for submission of seller feedback.

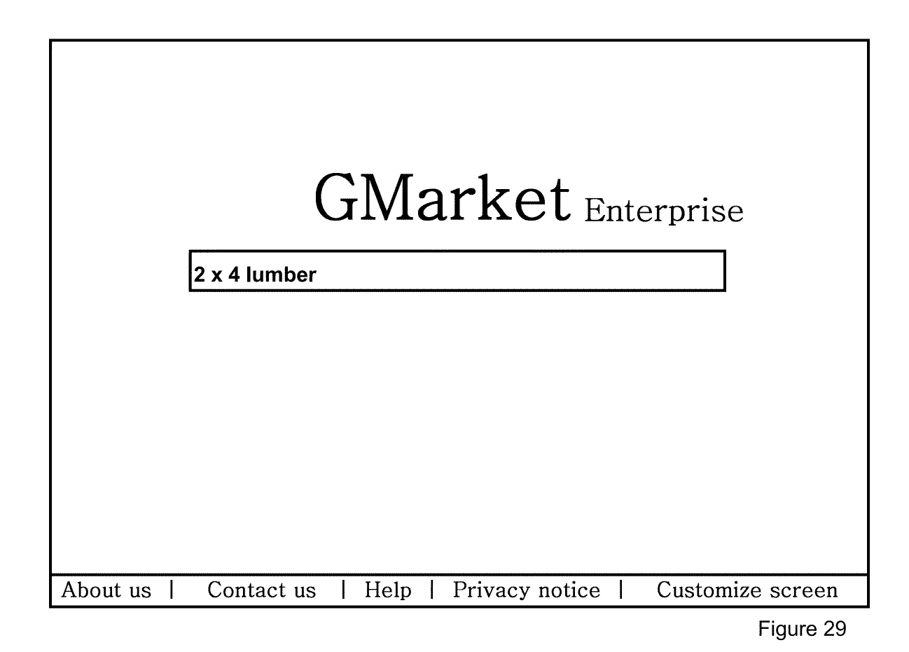

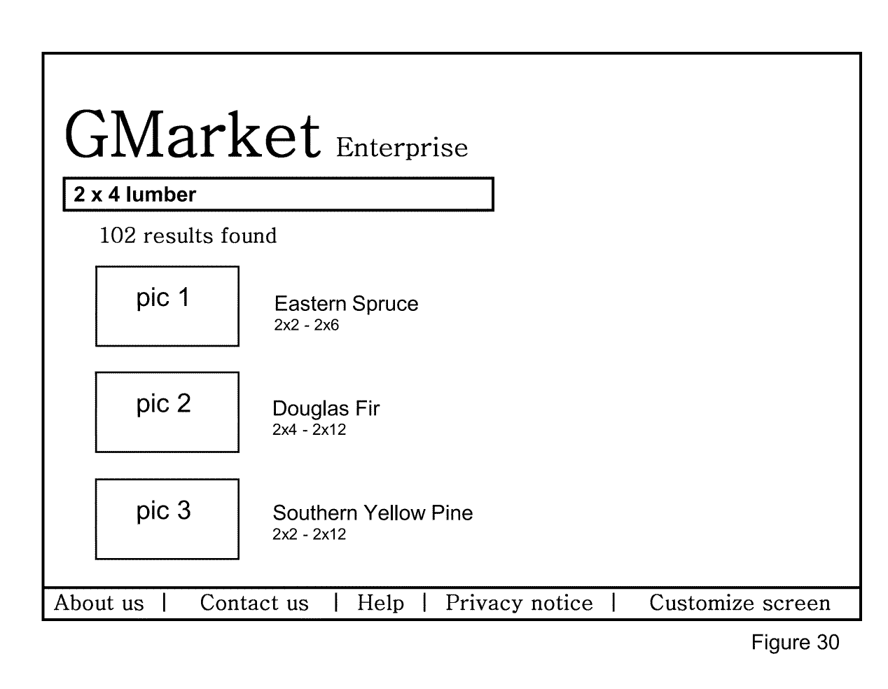

FIGS. 29-33 illustrate components of a system user interface in accordance with an implementation of the commercial transaction process and system of FIGS. 7-10. Specifically, FIG. 29 illustrates a search interface enabling the operation of step 700 in FIG. 7. FIG. 30 provides a search result display of items in step 725.

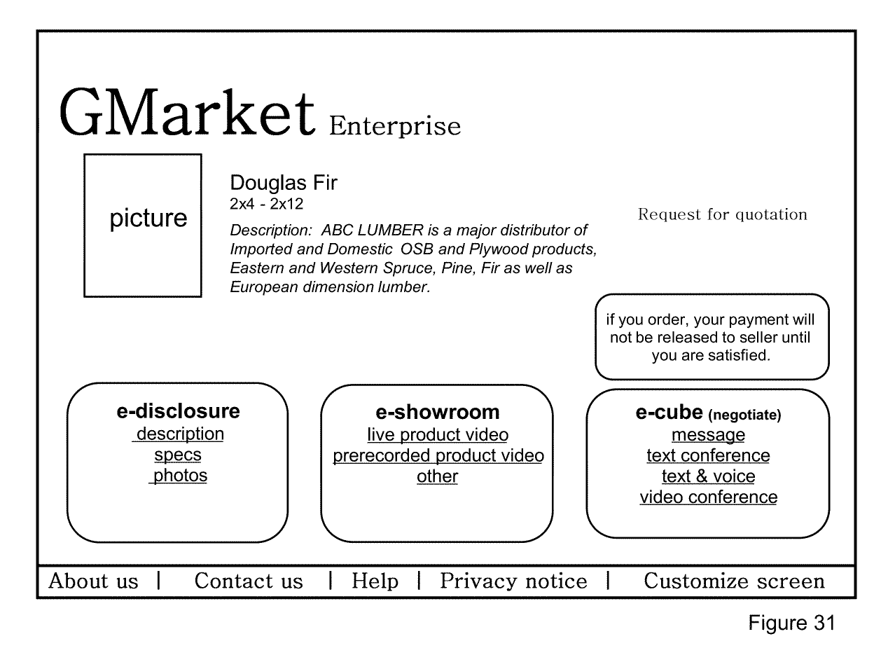

FIG. 31 illustrates an item selected in step 730. To obtain comprehensive information, including not only appearance but also functionality, as well as to be able to negotiate, the previously described facilities are provided for enterprise users of the system: e-disclosure, e-showroom and e-cube.

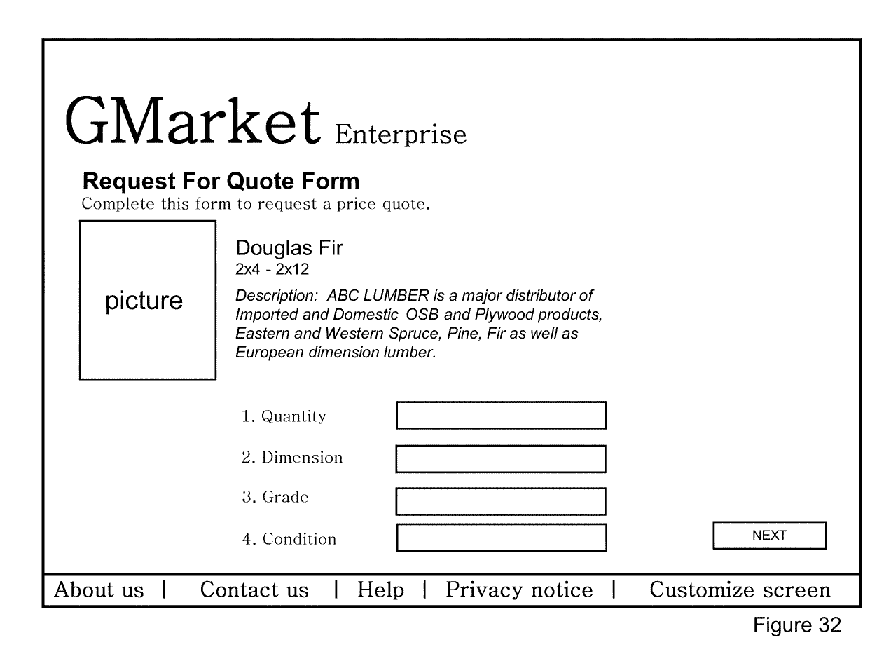

FIG. 32 provides a form for entry of RFQ information in step 745.

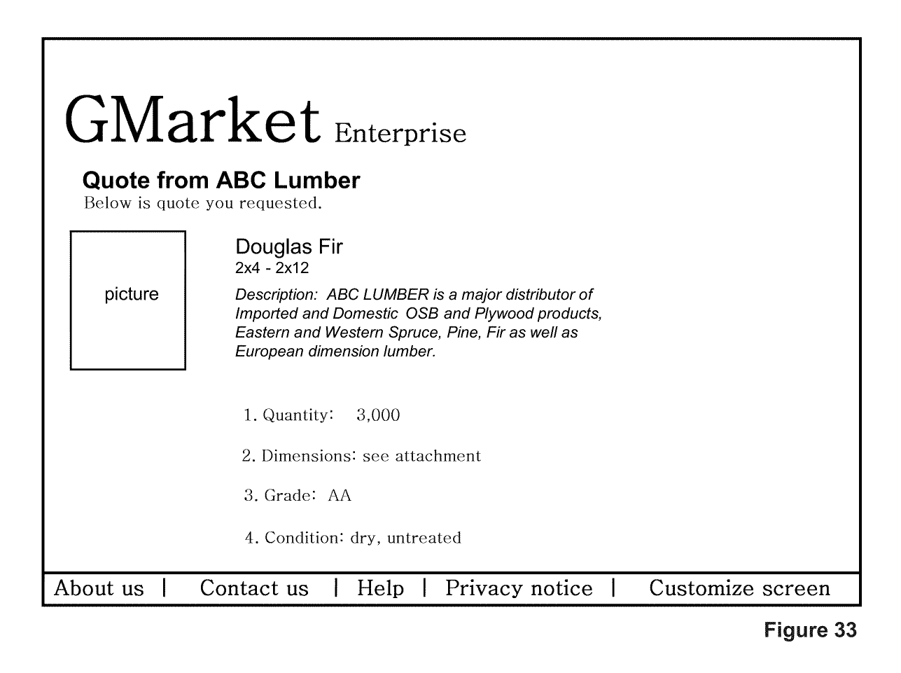

FIG. 33 illustrates conveyance of an RFQ to a seller in step 760.

It is important to note that the procurement system, methods and implementation illustrated herein can be beneficially utilized for procurement of not only physical goods, but also of services. Preferably, software and systems will be configured to enable transactions for services as well.

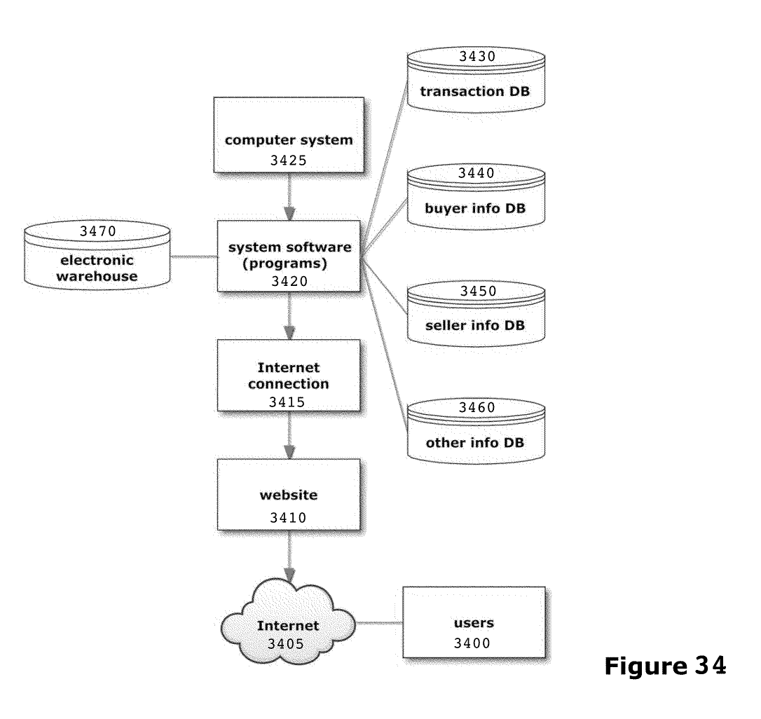

FIG. 34 is a schematic block diagram of an exemplary system for implementing the above-described processes and user interactions. Users 3400 (which may include both buyers and sellers) access the GMarket system via Internet 3405. The GMarket system includes web server 3410, which presents the GMarket user interface (including displays of FIGS. 11-33) to users 3400 via Internet 3405. GMarket system software 3420, implemented on computer system 3425, operates to execute the processes and operations described above, including but not limited to functionality supporting the steps in FIGS. 4-10, as well as presentation of the user interface displays of FIGS. 11-33. System software 3420 operates to access a number of databases containing information required for implementation of the above-described GMarket system.

Electronic warehouse database 3470 contains information describing items available for sale using the system of FIG. 34. Transaction database 3430 contains information relating to transactions being conducted on the system of FIG. 34. Buyer information database 3440 contains account information for users of the system seeking to make purchases. Seller information database 3450 contains account information for users of the system seeking to sell items. Database 3460 contains other information to support the above-described operation, processes and user interface.

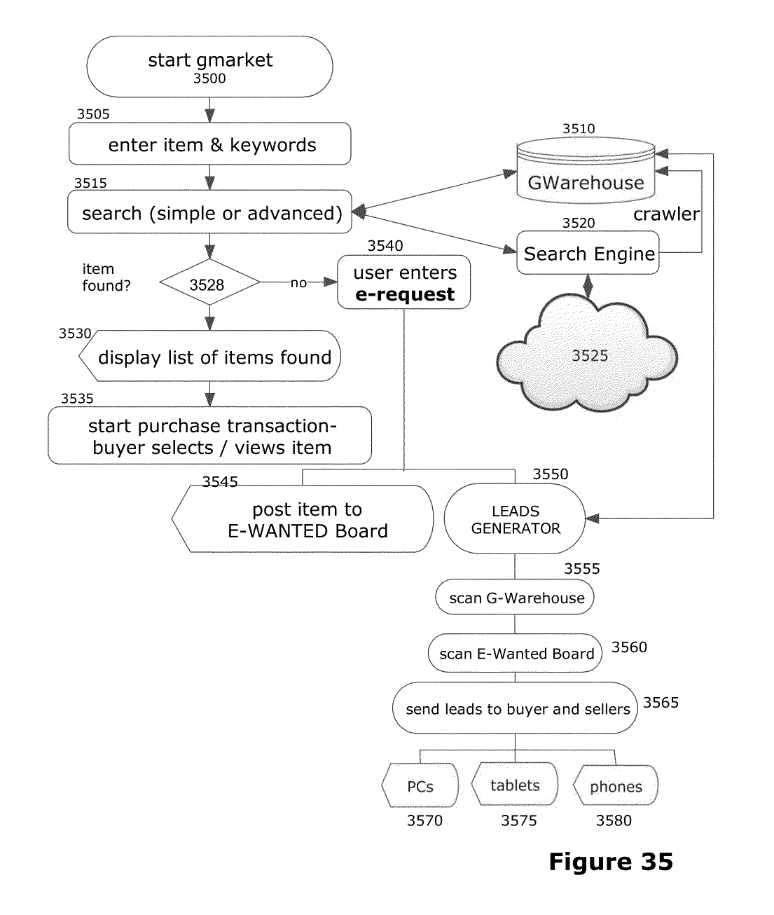

In accordance with another aspect of the illustrated embodiments, another important facility is provided and illustrated in FIG. 35. This facility is called e-requests, and provides the ability for the user to generate requests for items not found in a search of the G-Warehouse. Looking back for a moment at FIG. 4, it was assumed in the operation illustrated in FIG. 4 that when a search 415 for an item is conducted, generally some matching item(s) will be found and displayed as a list of items (430). That is generally true, but depending on the item being searched for and the contents of the G-Warehouse, there may be cases when an item cannot be found. FIG. 35 illustrates system operation in such a case, when the e-request facility is triggered.

Looking now at FIG. 35, in accordance with an exemplary embodiment, a user begins using the gmarket system (step 3500) and enters an item name or descriptive keywords indicative of an item sought after (step 3505). A search is performed (step 3515) of GWarehouse database 3510. A determination is then made as to whether the item searched for was found (step 3528). If so, the search results are displayed (step 3530) and the user can select an item and begin a purchase transaction (step 3535). However, if a potential buyer cannot find a desired item, he/she can enter an e-request (step 3540) for that item in the system. The system illustrated in FIG. 35 will do two things: a) enter the request in an e-wanted board (step 3545), which can be viewed and searched by all users at all times; and b) execute a Leads Generator software module (step 35550) to conduct a search in the e-warehouse for other similar items (step 3555), and scan the e-wanted board (step 3560) in an effort to identify matches between products desired by buyers, and similar products offered by sellers. In step 3565, leads are sent to buyers and sellers. More specifically, buyers with e-wanted postings may receive notices indicating that while the sought-after item is unavailable, one or more sellers with similar items have been identified and may be suitable for contacting about the sought-after item.

Meanwhile, sellers are alerted that somebody is looking for items similar to what they have available for sale. Accordingly, if the seller actually has the sought-after item or the ability to obtain it, they may be more likely to list the item in the GWarehouse, thereby satisfying the prospective buyer's need and expanding the breadth of inventory available through the system. Alerts may be sent to buyers and sellers via PCs 3570, tablets 3575, mobile phones 3580 or other means for electronic communication. Alerting both buyers and sellers of similarities and near-matches maximizes opportunities for parties to initiate contact with one another and potentially transact business. That said, it is also understood that alternative embodiments could be implemented in which “near matches” between sought-after and available products are sent to only the buyers or only the sellers.

While the operational embodiment of FIG. 35 illustrates the operation of leads generator module 3550 in response to entry of an e-request, it is understood and expressly contemplated that other modes of operation could be utilized instead of or in addition to that illustrated. For example, the leads generator could run scans of the G-Warehouse and E-Wanted Board periodically, or even continually, in order to identify matches or similarities between items sought-after and items available, particularly since it is contemplated that new items will continually become available within and be removed from the G-Warehouse. Also, it may be desirable to periodically clean up the E-Wanted board by expiring old listings, or by enabling buyers to remove their E-Wanted listings.

E-requests may be maintained within a database, which may include information indicative of the frequency or number of times prospective buyers have requested items not otherwise available for sale. In some embodiments, it may be desirable to make this desired item information available to the community of sellers, thereby further prompting sellers to offer for sale items of most interest to the web site's buyer community.

It may also be desirable in some embodiments to utilize e-requests as a basis for expanding the pool of sellers. For example, entry of an e-request in step 3540 may further trigger search engine 3520 to search Internet 3525 for a matching item. If a matching item is located via an Internet retailer, but not within GWarehouse 3510, an invitation to list products (particularly the matching item) within GWarehouse 3510 may be sent to the Internet retailer, thereby continually expanding the marketplace of products available within the GWarehouse.

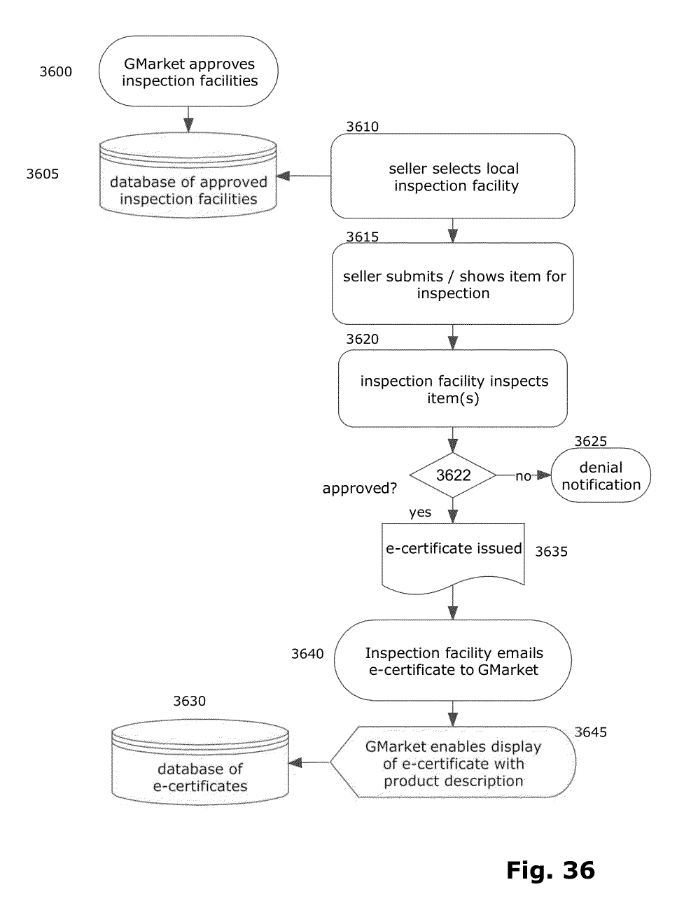

FIG. 36 shows another innovative facility of the invention which is referred to herein as the e-certificate (also called e-certified when applied to a product or service posted for sale in GMarket). Through the e-certified facility, characteristics of goods (such as authenticity, quality, condition, place of manufacture, used or new status, degree of usage, current location, etc.) can be voluntarily certified to provide more comfort to buyers and more credibility to sellers. This can be especially attractive to both sides for large ticket items, because it can be an enabler for a transaction that otherwise may not happen. The certification can be performed by one or more merchandise certification authorities.

Operationally in the illustrated embodiment, certification authority inspection facilities are first associated with the web site, for example, approved by GMarket (step 3600) and entered into a database of approved inspection resources (step 3605). Then, during the process of preparing an item for listing in the GWarehouse, a seller selects an inspection facility from amongst the database of approved facilities (step 3610). For example, a certified gemologist may be selected to inspect jewels, or a car repair chain may be selected to inspect a used automobile. The seller then makes the item available for inspection by the selected inspector (step 3615). Depending on the item, selected inspector and fee agreement, the seller may take the item to the inspector, or the inspector may come to the location of the item.

In step 3622, a determination is made by the inspector as to whether the merchandise can be certified. If not, the e-certification is denied and a denial notification is emailed to the seller and/or made available on the seller's GMarket account (step 3625). If so, the e-certification is granted and an e-certificate is issued (step 3635). The inspection facility emails, uploads or otherwise electronically transmits the e-certificate to GMarket (step 3640) for storage within e-certificate database 3630. GMarket then enables the posting of the e-certificate along with the product description in the GMarket site (step 3645). In some embodiments, the e-certification facility will carry a reasonable charge which can make this facility profitable for the system and also advantageous for sellers and buyers, because an e-certificate for a product may be in many cases the enabler that makes a transaction possible and/or faster.

Another important facility that the system can provide to inspire trust and confidence in buyers and sellers through the use of a reputable independent party, a Trust Entity, to hold the escrow payments made by buyer. For instance, instead of paying the GMarket system directly, the buyer may be given the option in a transaction to send payment to the Trust Entity, which may be a reputable bank or other respected financial institution to hold the escrow payment until authorized to pay by GMarket. Upon receipt of such authorization, the Trust Entity pays the seller. Typically, the relationship between GMarket and the Trust Entity will be set up in advance. Optionally, approved Trust Entities may be provided with a user or systems interface to the GMarket system, in order to, e.g., facilitate electronic transmission of funds between the GMarket system and the Trust Entity, or facilitate transmission of payment approval to the Trust Entity. Such a user or system interface may be implemented using some combination of web server, XML, email, database interface or other means of electronic data communication.

In some embodiments, parties to a transaction may be given the option to select a mutually agreeable trust entity from amongst a number of available trust entities. Furthermore, different trust entities may offer varying fee structures or service levels. For example, in addition to escrow of transaction funds, the trust entity may also take on responsibility for dispute resolution, acting as a third party neutral (e.g. see above) in the event of a dispute. Foreign currency exchange services can also be provided by the Trust Entity, particularly where the Trust Entity is a financial institution.

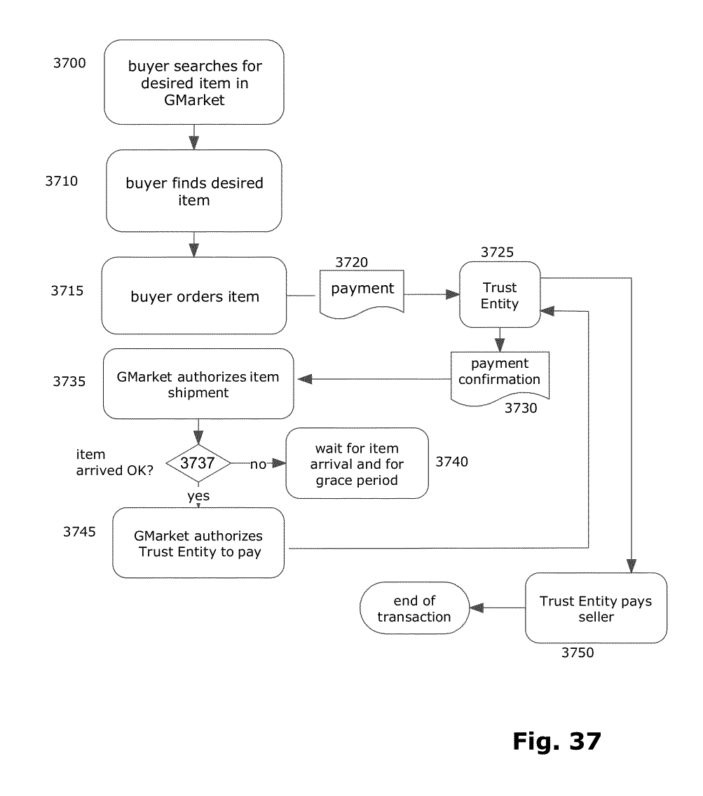

FIG. 37 illustrates an exemplary embodiment of system operation using a third party trust entity. In step 3700, a buyer searches for a desired item. The buyer locates a desired item (step 3710) and orders the item (step 3715). Payment 3720 is made to the Trust Entity 3725. A payment confirmation is then issued (step 3730), and the GMarket system authorizes shipment of the item by the seller (step 3735). In step 3737, a determination is made as to whether the item was received by the buyer. If so, the GMarket system authorizes the Trust Entity to pay the seller (step 3745). The Trust Entity 3725 pays the seller (step 3750) and the transaction is completed.

Some of the embodiments illustrated above are explained in the context of the sale of goods, articles or items. However, it is understood and expressly contemplated that those embodiments and others within the scope of the present invention could also be readily utilized in connection with the sale of services.

The foregoing description and drawings merely explain and illustrate the invention and the invention is not limited thereto except insofar as the appended claims are so limited, as those skilled in the art who have the disclosure before them will be able to make modifications and variations therein without departing from the scope of the invention.

1. A computer-based system for conducting electronic commercial transactions amongst a plurality of buyers and sellers via the Internet, comprising:
an electronic warehouse database containing information describing one or more items available for sale;
one or more databases containing transaction data, buyer information and seller information;
a computer application operable to manage the databases, the computer application further operable to communicate with one or more buyers and sellers via a web server in order to conduct a sales transaction using the Internet;
an electronic disclosure facility, implementing data storage and communication mechanisms through which information describing said one or more items available for sale is stored;
an electronic showroom facility, said facility including audiovideo storage and playback modules adapted for conveying item information between a seller and one or more buyers.

2. The computer-based system of claim 1, in which said electronic disclosure facility data storage and communication mechanisms include text describing an item, standardized item specifications, and standardized digital photographs of an item.

3. The computer-based system of claim 1, in which said computer-implemented electronic showroom facility includes a videoconferencing module enabling real-time two-way audiovisual communications between a seller and one or more buyers via the Internet.

4. The computer-based system of claim 3, in which said real-time two-way audiovisual communications can be stored within said electronic showroom facility for subsequent playback to buyers.

5. The computer-based system of claim 1, further comprising an electronic cubicle facility providing one or more communication modules through which a seller and buyer can negotiate terms of a transaction.

6. The computer-based system of claim 5, in which said one or more communications modules includes one or more of the following: email messaging, text conference, text and voice conferencing, and videoconferencing.

7. The computer-based system of claim 1, further comprising a dispute resolution module facilitating resolution of disputes concerning transactions implemented via the system, through evaluation of information contained within the electronic disclosure facility and the electronic showroom facility.

8. The computer-based system of claim 5, further comprising a dispute resolution module facilitating resolution of disputes concerning transactions implemented via the system, through evaluation of information contained within the electronic disclosure facility, the electronic showroom facility and the electronic cubicle facility.

9. The computer-based system of claim 8, further comprising an arbitrator web portal through which an arbitrator can access transaction information stored within the system and communicate a dispute determination to a buyer and seller.

10. A computer-implemented method for resolving a dispute between first and second parties to a transaction conducted via an electronic commerce system, comprising the steps of:
providing a website-based complaint user interface through which the first party can submit information describing the dispute;
providing a website-based neutral user interface through which a neutral party can access (a) information provided by the first party describing the dispute, and (b) information relating to the transaction stored within the electronic commerce system;
communicating an initial determination of the dispute provided by a neutral to the first and second parties via an electronic communication.

11. The method of claim 10, in which the step of providing a website-based neutral user interface through which a neutral party can access information relating to the transaction stored within the electronic commerce system, is further comprised of the substeps of:
providing an electronic disclosure facility containing product information, which facility is accessible to a neutral; and
providing access to prior communications between the seller and the buyer stored within the system to a neutral.

12. The method of claim 10, further comprising the steps of:
providing a web-based portal through which the parties can indicate rejection of the initial determination;
in response to rejection of an initial determination, providing an online hearing facility through which the buyer and the seller can communicate with a neutral via the Internet;
notifying the buyer and the seller of a final determination by the neutral;
implementing the neutral's final determination.

13. The method of claim 12, further comprising the step of assessing via an electronic computer system a monetary charge to the losing party in the neutral's final determination.

14. A computer-based system for conducting electronic commercial transactions amongst a plurality of buyers and sellers via the Internet, comprising:
an electronic warehouse database containing information describing one or more items available for sale by said plurality of sellers;
one or more databases containing transaction data, buyer information and seller information;
a computer application operable to manage the databases, the computer application further operable to communicate with one or more buyers and sellers via a web server in order to conduct a sales transaction using the Internet;
said web server providing a user interface through which parties to a transaction can select one from amongst a plurality of trust entities to be utilized in connection with said sales transaction.

15. The system of claim 14, in which said plurality of trust entities include one or more independent financial institutions.

16. The system of claim 14, further comprising a computer-implemented data communications interface between said computer application and said trust entities.

17. The system of claim 16, in which said computer-implemented data communications interface is adapted for transmitting instructions to release funds to a seller in response to satisfaction of predetermined conditions in said sales transaction.

18. A computer-implemented method for conducting an electronic commercial transaction via the Internet, comprising the steps of:
providing an Internet-accessible web site on which a plurality of sellers list items available for sale;
receiving a search request for a desired item from a buyer via said Internet-accessible web site;
identifying one or more relevant sellers, which relevant sellers have items listed as available for sale via said Internet-accessible web site which are similar to said desired item;
notifying said one or more relevant sellers by said Internet-accessible web site that said desired item was sought after by a buyer.

19. The method of claim 18, in which the step of identifying one or more relevant sellers is further comprised of the preceding substep of determining that said desired item is not listed for sale within said Internet-accessible web site.

20. The method of claim 19, further comprising the step of maintaining a database of desired items subject of searches by buyers, which are not listed for sale within said Internet-accessible web site.

21. The method of claim 20, further comprising the step of publishing to said sellers via said Internet-accessible web site a list of items sought after by buyers but otherwise unavailable on said web site.

22. A computer-implemented method for conducting an electronic commercial transaction via the Internet, comprising the steps of:
providing an Internet-accessible web site on which a plurality of sellers list items available for sale;
associating one or more merchandise certification authorities with said web site;
receiving from one of said certification authorities via electronic communication a certification of an item listed for sale by one of said sellers;
publishing via said web site information a sales listing for said item which includes information from said certification.

23. The method of claim 22, further comprising the step of presenting via said Internet-accessible web site a seller with a list of certification authorities associated with said web site and having certification expertise associated with an item to be made available for sale by said seller.

24. The method of claim 22, further comprising the step of providing a web-based communications portal accessible to said certification authorities via which said certification authorities can upload certification information.

25. The method of claim 22, further comprising the step of storing said certification within a certification information database.
